(19) United States
(12) Patent Application Publication
(10) Pub. No.: US 2026/0321051 A1
(43) Pub. Date: Oct. 15, 2026

(54) WEARABLE DEVICE COMPRISING FINGERPRINT SENSOR, AND OPERATING METHOD THEREFOR

(71) Applicant: Samsung Electronics Co., Ltd., Suwon-si (KR)

(72) Inventors: Byunghyun LEE, Suwon-si (KR); Geunwoo JEONG, Suwon-si (KR); Jihun HEO, Suwon-si (KR); Jihee HONG, Suwon-si (KR); Dasom LEE, Suwon-si (KR); Jeongmin PARK, Suwon-si (KR); Yongha CHOI, Suwon-si (KR)

(21) Appl. No.: 19/466,977

(22) Filed: Feb. 2, 2026

Related U.S. Application Data
(63) Continuation of application No. PCT/KR2024/007621, filed on Jun. 4, 2024.

(30) Foreign Application Priority Data
Sep. 5, 2023 (KR) 10-2023-0117432
Oct. 5, 2023 (KR) 10-2023-0132659

(51) Int. Cl. G06V 40/13; G06F 3/02; G06F 3/033; G06F 3/038

(52) U.S. Cl. CPC G06V 40/13; G06F 3/02; G06F 3/033; G06F 3/038; G06F 2203/0331

(57) ABSTRACT

A wearable device is provided. The wearable device includes a housing including at least one hole into which a finger of a user is inserted, a button disposed on an inner surface facing the at least one hole of the housing, a fingerprint sensor disposed on the button, memory for storing at least one computer program including computer-executable instructions, and at least one processor communicatively coupled to the button, the fingerprint sensor and the memory, wherein the instructions, when executed by the at least one processor individually or collectively, cause the wearable device to detect a fingerprint input event through the button, in response to detecting the fingerprint input event, obtain a fingerprint input for the fingerprint sensor, and obtain fingerprint information of the user through the fingerprint sensor based on a sliding input to the fingerprint sensor.

### CROSS-REFERENCE TO RELATED APPLICATIONS

This application is a continuation application, claiming priority under 35 U.S.C. § 365(c), of an International application No. PCT/KR2024/007621, filed on Jun. 4, 2024, which is based on and claims the benefit of a Korean patent application number 10-2023-0117432, filed on Sep. 5, 2023, in the Korean Intellectual Property Office, and of a Korean patent application number 10-2023-0132659, filed on Oct. 5, 2023, in the Korean Intellectual Property Office, the disclosure of each of which is incorporated by reference herein in its entirety.

### BACKGROUND

### 1. Field

The disclosure relates to a wearable device including a fingerprint sensor and an operating method thereof.

### 2. Description of Related Art

As functions of a mobile electronic device are gradually diversified, the mobile electronic device is implemented in the form of a multimedia device, and a structural part and a software part of the device are improved. In recent, wearable devices such as a smart watch, smart glasses, and a smart ring among various mobile electronic devices are increasing in use. The smart ring may be worn on a user’s finger. The user may control the smart ring using a voice command, or may control the smart ring through a touch input.

As the use of the electronic device increases, various functions may be provided in the electronic device. For example, the electronic device may perform security and authentication for the user of the electronic device, using password, pattern recognition, and fingerprint recognition schemes.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a wearable device including a fingerprint sensor and an operating method thereof.

Additional aspects will be set forth in part in the description which follows and, in part, will be apparent from the description, or may be learned by practice of the presented embodiments.

In accordance with an aspect of the disclosure, a wearable device is provided. The wearable device includes a housing including at least one hole into which a finger of a user is inserted, a button disposed on an inner surface facing the at least one hole of the housing, a fingerprint sensor disposed on the button, memory for storing at least one computer program including computer-executable instructions, and at least one processor communicatively coupled to the button, the fingerprint sensor and the memory, wherein the instructions, when executed by the at least one processor individually or collectively, cause the wearable device to detect a fingerprint input event through the button, in response to detecting the fingerprint input event, obtain a fingerprint input for the fingerprint sensor, and obtain fingerprint information of the user through the fingerprint sensor based on a sliding input to the fingerprint sensor.

In accordance with another aspect of the disclosure, an operating method of a wearable device is provided. The operating method of a wearable device includes detecting, by the wearable device, a fingerprint input event through a button disposed on an inner surface facing at least one hole of a housing including the at least one hole into which a finger of a user is inserted, in response to detecting the fingerprint input event, obtaining, by the wearable device, a fingerprint input for a fingerprint sensor disposed on the button, and obtaining, by the wearable device, fingerprint information of the user through the fingerprint sensor based on a sliding input to the fingerprint sensor.

In accordance with another aspect of the disclosure, one or more non-transitory computer-readable storage media storing one or more computer programs including computer-executable instructions that, when executed by one or more processors of a wearable device individually or collectively, cause the wearable device to perform operations are provided. The operations including detecting, by the wearable device, a fingerprint input event through a button disposed on an inner surface facing at least one hole of a housing including the at least one hole into which a finger of a user is inserted, in response to detecting the fingerprint input event, obtaining, by the wearable device, a fingerprint input for a fingerprint sensor disposed on the button, and obtaining, by the wearable device, fingerprint information of the user through the fingerprint sensor based on a sliding input to the fingerprint sensor.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device within a network environment according to an embodiment of the disclosure;

FIG. 2 is a diagram illustrating a wearable device according to an embodiment of the disclosure;

FIG. 3 is a diagram illustrating a wearable device worn on a user’s finger according to an embodiment of the disclosure;

FIG. 4 is a block diagram illustrating a configuration of a wearable device according to an embodiment of the disclosure;

FIGS. 5A and 5B are cross-sectional views of a wearable device according to an embodiment of the disclosure;

FIGS. 6A and 6B are cross-sectional views of a wearable device worn by a user according to an embodiment of the disclosure;

FIG. 7 is a cross-sectional view illustrating a wearable device including a button according to an embodiment of the disclosure;

FIG. 8 is a cross-sectional view illustrating a wearable device including a magnet according to an embodiment of the disclosure;

FIG. 9 is a cross-sectional view illustrating a wearable device including a button according to an embodiment of the disclosure;

FIG. 10 is a cross-sectional view illustrating a wearable device including an elastic member according to an embodiment of the disclosure;

FIG. 11 is a cross-sectional view illustrating a wearable device including a button according to an embodiment of the disclosure;

FIG. 12 is a diagram illustrating a wearable device including an elastic member according to an embodiment of the disclosure;

FIG. 13 is a flowchart illustrating an operating method of a wearable device according to an embodiment of the disclosure;

FIG. 14 is a flowchart illustrating a process of fingerprint registration operations according to an embodiment of the disclosure;

FIG. 15 is a flowchart illustrating a process of fingerprint authentication operations according to an embodiment of the disclosure;

FIG. 16 is a flowchart illustrating a process for controlling power of a fingerprint sensor based on a button state according to an embodiment of the disclosure; and

FIG. 17 is a flowchart illustrating a process for determining a user’s wearing state based on a button state according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

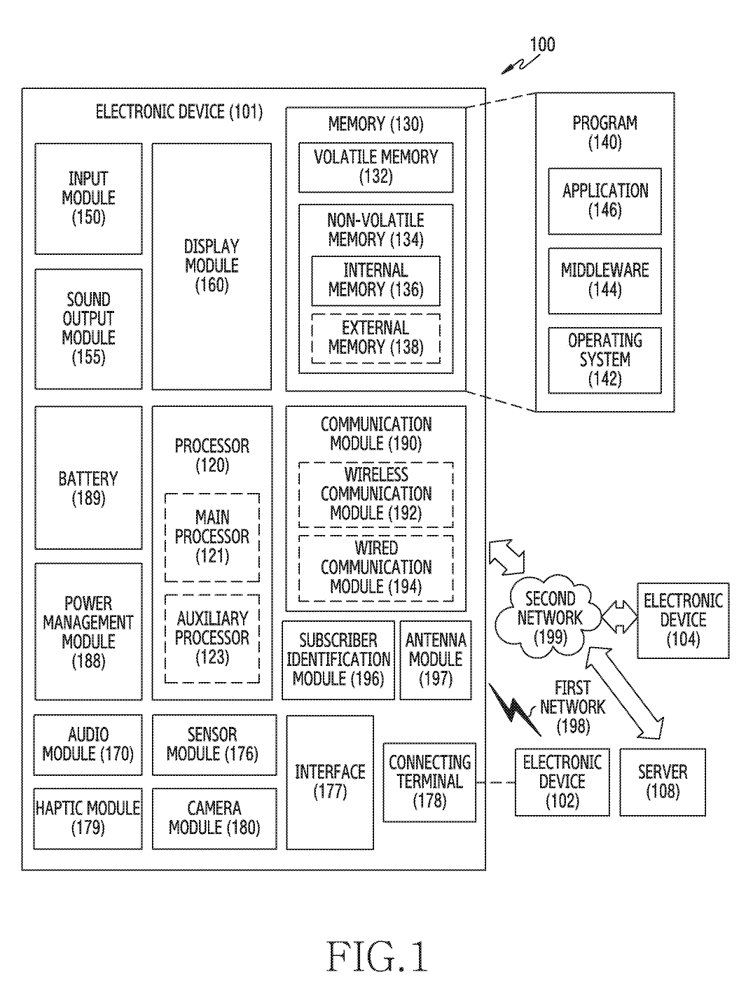

Hereafter, a device to which various embodiments disclosed in this document may be applied or expanded shall be specified and expanded with reference to FIG. 1.

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth^{TM}, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or user plane (U-plane) latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

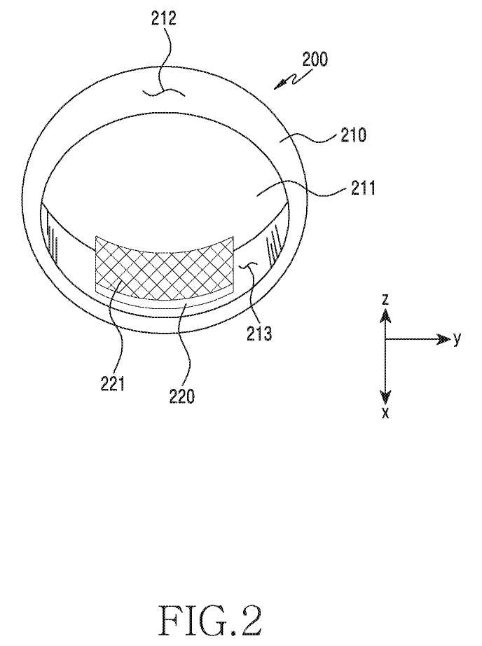

FIG. 2 is a diagram illustrating a wearable device 200 according to an embodiment of the disclosure.

The wearable device 200 (hereafter, referred to as an electronic device 200) of FIG. 2 may be referred to by the electronic device 101 of FIG. 1.

Referring to FIG. 2, the electronic device 200 according to an embodiment may include a smart ring. For example, the electronic device 200 may be a ring-type wearable device. However, it is not limited thereto. For example, the electronic device 200 may include various types of the wearable device which may be worn on a user’s finger.

According to an embodiment, the electronic device 200 may have a cylindrical shape or a donut shape. For example, the electronic device 200 may include at least one hole 211 penetrating the electronic device 200. For example, referring to FIG. 2, the at least one hole 211 may be opened in the x direction and/or the -x direction. However, it is not limited thereto. For example, the electronic device 200 may have various shapes wearable on a user’s finger.

According to an embodiment, the electronic device 200 may be worn on the user’s finger. For example, the user’s finger may be inserted into the at least one hole 211. In one example, the electronic device 200 may be worn on one finger of the user, or may be worn across a plurality of fingers of the user.

According to an embodiment, the electronic device 200 may include a housing 210 for forming an exterior of the electronic device 200, and a button 220 disposed on the housing 210. A surface of the electronic device 200 (e.g., a surface of the housing 210) may be divided into an outer circumferential surface (or, an outer surface) 212 facing away from the user’s finger wearing the electronic device 200 and an inner circumferential surface (or, an inner surface) 213 facing in the direction of the user’s finger wearing the electronic device 200.

According to an embodiment, at least a portion of the button 220 may be accommodated within the housing 210. For example, at least a portion of the button 220 may be accommodated within a recess formed in the housing 210.

According to an embodiment, the button 220 may be disposed to face the at least one hole 211 of the electronic device 200. For example, the button 220 may be disposed on the inner surface 213 of the housing 210. In one example, at least a portion of the button 220 may protrude in a direction toward the hole 211 based on the inner surface 213. For example, in case that the user wears the electronic device 200, at least a portion of the button 220 may contact at least a portion of the user’s finger.

According to an embodiment, since the button 220 is disposed on the inner surface 213 of the electronic device 200 (or, disposed to face the at least one hole 211), it is possible to prevent the button 220 and/or a fingerprint sensor disposed in the button from being damaged by external impact.

According to an embodiment, the electronic device 200 may include at least one sensor. For example, the electronic device 200 may include a fingerprint sensor (not shown) disposed on the button 220. In one example, the fingerprint sensor may be disposed adjacent to a first surface 221 (e.g., a surface facing in the +z direction) facing the hole 211 of the button 220. For example, the fingerprint sensor may be disposed on the first surface 221 of the button 220.

According to an embodiment, the fingerprint sensor may provide at least one fingerprint sensing scheme. For example, the fingerprint sensor may generate fingerprint information corresponding to the user’s fingerprint based on the amount of current which changes, as the user’s finger using the electronic device 200 slides (or swipes) at least a portion of a fingerprint sensing region. However, it is not limited thereto. For example, as the user’s finger using the electronic device 200 slides (or swipes) at least a portion of the fingerprint sensing region, the fingerprint sensor may generate fingerprint information corresponding to the user’s fingerprint using a photosensitive diode. For example, as the user’s finger using the electronic device 200 slides (or swipes) at least a portion of the fingerprint sensing region, the fingerprint sensor may also generate fingerprint information corresponding to the user’s fingerprint using a path difference of ultrasonic waves generated through a piezoelectric element. In one example, the fingerprint sensing region of the fingerprint sensor may be included in some region or the entire region of the button 220 of the electronic device 200. For example, the fingerprint sensing region of the fingerprint sensor may be included in a region of the button 220 where the fingerprint sensor is disposed.

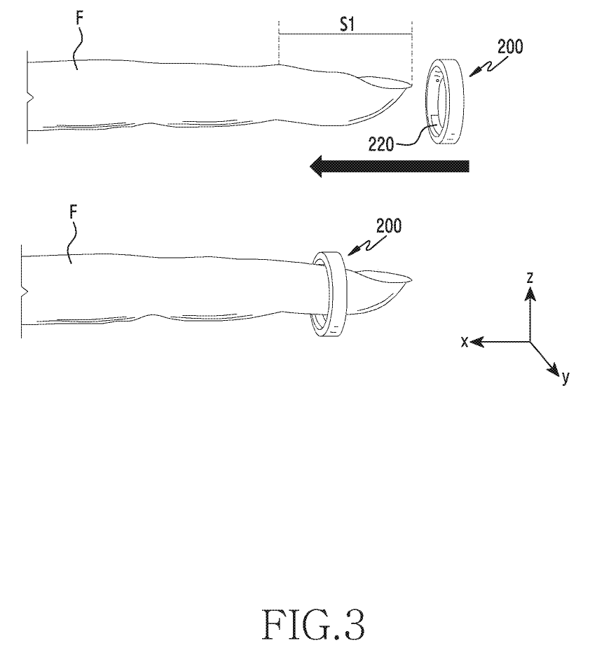

FIG. 3 is a diagram illustrating a wearable device 200 (hereafter, referred to as the electronic device 200) worn on a user’s finger according to an embodiment of the disclosure.

The electronic device 200 of FIG. 3 may be referred to by the electronic device 101 of FIG. 1 and/or the electronic device 200 of FIG. 2. The same terms and/or the same reference numerals are used for configurations identical or substantially identical to those described above, and redundant descriptions shall be omitted.

Referring to FIG. 3, the electronic device 200 may be worn on a user’s finger F. For example, while the user’s finger F is inserted into the electronic device 200 (e.g., the at least one hole 211 of FIG. 2), the electronic device 200 may be worn on the user’s finger F by sliding along the user’s finger F.

According to an embodiment, the electronic device 200 may obtain user’s fingerprint information through the fingerprint sensor disposed on the button 220. For example, the electronic device 200 may obtain the user’s fingerprint information from the user’s finger contacting the button 220. For example, the electronic device 200 may be slid along the user’s finger F, while the user presses the button 220. While the user’s finger F presses the button 220, as the user’s finger F (e.g., a first portion S1) slides (or swipes) at least a portion of the fingerprint sensing region (e.g., the region where the fingerprint sensor is disposed) of the button 220, the electronic device 200 may obtain the fingerprint information of the user’s finger F. For example, the electronic device 200 may obtain the fingerprint information of the first portion S1 of the user’s finger F.

According to an embodiment, the electronic device 200 may obtain the user’s fingerprint information required for fingerprint registration or fingerprint authentication. The electronic device 200 may register the obtained fingerprint information as fingerprint information of the user wearing the electronic device 200, and/or perform the fingerprint authentication using the obtained fingerprint information.

According to an embodiment, in case that the user wears the electronic device 200, the electronic device 200 may concurrently obtain the user’s fingerprint information by scanning a fingerprint image corresponding to the user’s fingerprint input (e.g., a sliding input) (e.g., by scanning fingerprint images at once, or scanning a fingerprint image at a specific timing). Since the electronic device 200 obtains the user’s fingerprint information upon the user’s wearing of the electronic device 200, the user may easily acquire the fingerprint information.

Since the electronic device 200 obtains the user’s fingerprint information by scanning the fingerprint image corresponding to the user’s fingerprint input (e.g., the sliding input), the user may acquire the fingerprint information more easily even in case that an internal space of the electronic device 200 is narrow to limit the size of the fingerprint sensor disposed inside the electronic device 200.

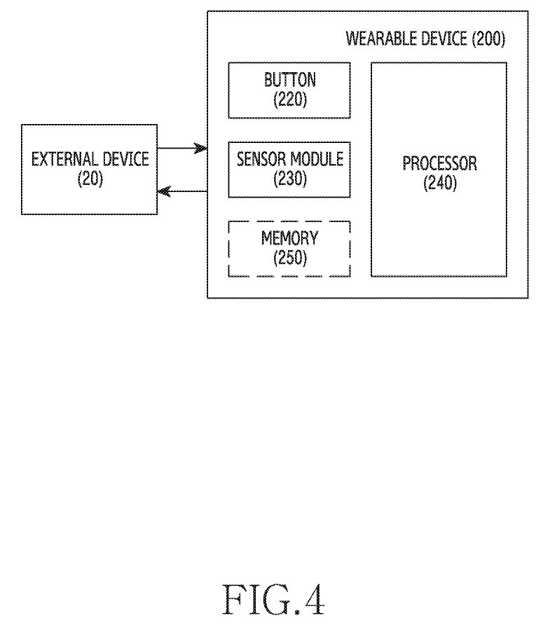

FIG. 4 is a block diagram illustrating a configuration of a wearable device 200 (hereafter, referred to as an electronic device 200) according to an embodiment of the disclosure.

The electronic device 200 of FIG. 4 may be referred to by the electronic device 101 of FIG. 1, the electronic device 200 of FIG. 2 and/or the electronic device 200 of FIG. 3. The same terms and/or the same reference numerals are used for components identical or substantially identical to those described above, and redundant descriptions thereof shall be omitted.

Referring to FIG. 4, the electronic device 200 according to an embodiment may include a button 220, a sensor module 230, and at least one processor 240 (e.g., the processor 120 of FIG. 1). However, the components of the electronic device 200 are not limited thereto. For example, the electronic device 200 may omit at least one component described above, or may further include at least one component. For example, the electronic device 200 may further include memory 250, a battery (not shown), a circuit board (not shown) and/or a communication module (not shown).

According to an embodiment, the sensor module 230 may include a fingerprint sensor. The fingerprint sensor may acquire fingerprint information of the user using an electrostatic scheme. For example, the fingerprint sensor may acquire a fingerprint by using a principle that a part (a ridge) where the fingerprint touches an electrode is detected, and a part (a valley) not touched is not detected. However, it is not limited thereto. For example, the fingerprint sensor may acquire fingerprint information using at least one of an optical scheme and an ultrasonic scheme.

According to an embodiment, a sensor array of the fingerprint sensor may be configured with a plurality of lines for receiving fingerprint images. The at least one processor 240 may calculate a sliding speed by checking duplication of images received by each line of the sensor array of the fingerprint sensor. The at least one processor 240 may remove the duplicate fingerprint image by each line and thus extract an original image of the fingerprint.

According to an embodiment, the sensor module 230 may include a touch sensor (not shown) for detecting contact by a user’s body part and receiving a touch input from the user, and/or a pressure sensor (not shown) for receiving an input of the user pressing (or clicking) the button 220.

According to an embodiment, the at least one processor 240 may be electrically and/or operatively connected with the button 220, the sensor module 230, the memory 250, the battery (not shown), the circuit board (not shown) and/or the communication module (not shown).

In an embodiment, hardwares of the electronic device 200 being operatively coupled may mean that a direct connection, or an indirect connection is established between the hardwares by wire or wirelessly, such that a second hardware is controlled by a first hardware among the hardwares.

According to an embodiment, the at least one processor 240 may detect a fingerprint input event through an input of the button 220. For example, the at least one processor 240 may detect the fingerprint input event through a user input of pressing the button 220 (or, clicking the button 220). For example, the at least one processor 240 may initiate a fingerprint registration operation and/or a fingerprint authentication operation through the input of the button 220.

According to an embodiment, the at least one processor 240 may initialize the fingerprint sensor, in response to detecting the fingerprint input event. For example, the at least one processor 240 may initialize a register of the fingerprint sensor to a default value. According to an embodiment, the at least one processor 240 may supply power to the fingerprint sensor, in response to detecting the fingerprint input event. For example, in case that the at least one processor detects the fingerprint input event, power consumed in the fingerprint sensor may be reduced by supplying the power to the fingerprint sensor.

According to an embodiment, the at least one processor 240 may obtain a fingerprint input for the fingerprint sensor, in response to detecting the fingerprint input event. For example, in response to detecting the fingerprint input event, the at least one processor 240 may determine whether the finger is recognized by the fingerprint sensor. For example, the at least one processor 240 may execute a finger on detection (FOD) mode to determine whether the fingerprint sensor recognizes the finger.

According to an embodiment, the at least one processor 240 may obtain fingerprint information of the user through the fingerprint sensor, based on a sliding input to the fingerprint sensor. For example, the at least one processor 240 may scan a user’s fingerprint through the fingerprint sensor, based on the sliding input of the user’s finger to the fingerprint sensor.

In one example, the at least one processor 240 may obtain first fingerprint information of the user through the fingerprint sensor, based on a first sensing scheme. For example, the at least one processor 240 may obtain the first fingerprint information by scanning fingerprint images corresponding to the fingerprint input at once. For example, the at least one processor 240 may sequentially obtain a plurality of fingerprint image frames, based on the first sensing scheme. The at least one processor 240 may obtain the first fingerprint information based on the plurality of fingerprint image frames obtained. For example, the at least one processor 240 may obtain the first fingerprint information by stitching at least a portion of the plurality of fingerprint image frames obtained. In one example, the at least one processor 240 may obtain the fingerprint information of the user based on the first sensing scheme in the fingerprint registration operation. However, it is not limited thereto. For example, the at least one processor 240 may also receive from an external device 20 the fingerprint information of the user obtained in the fingerprint registration operation of the external device 20.

In one example, the at least one processor 240 may obtain second fingerprint information of the user through the fingerprint sensor, based on a second sensing scheme. For example, the at least one processor 240 may obtain the second fingerprint information by scanning a fingerprint image at a specific time point corresponding to the fingerprint input. For example, based on the second sensing scheme, the at least one processor 240 may obtain a plurality of fingerprint image frames and select at least one fingerprint image frame from the plurality of fingerprint image frames. For example, the at least one processor 240 may select at least one optimal fingerprint image frame from the plurality of fingerprint image frames. The at least one processor 240 may obtain the second fingerprint information based on the at least one fingerprint image frame selected. For example, the at least one processor 240 may obtain the user’s fingerprint information based on the first sensing scheme or the second sensing scheme in the fingerprint authentication operation.

According to an embodiment, the at least one processor 240 may store the obtained fingerprint information of the user in the memory 250. For example, the at least one processor 240 may store the user’s first fingerprint information obtained in the fingerprint registration operation in the memory 250. However, it is not limited thereto. For example, the at least one processor 240 may also store the user’s fingerprint information received from the external device 20 in the memory 250.

According to an embodiment, the at least one processor 240 may compare at least a portion of the user’s fingerprint information stored in the memory 250 with at least a portion of the obtained user fingerprint information. For example, the at least one processor 240 may compare at least a portion of the first fingerprint information stored in the memory 250 in the fingerprint registration operation with the second fingerprint information obtained in the fingerprint authentication operation. According to an embodiment, the at least one processor 240 may be configured to determine whether to execute a designated operation, based on the comparison result.

According to an embodiment, the at least one processor 240 may execute calculation or data processing related to control and/or communication of at least one other components of the electronic device 200 using instructions stored in the memory 250 of the electronic device 200. According to an embodiment, the processor 240 may be understood to include at least one processor. For example, the processor 240 may be understood to include at least one of a central processing unit (CPU), a graphics processing unit (GPU), a micro controller unit (MCU), a sensor hub, a supplementary processor, an application processor, an application specific integrated circuit (ASIC), a field programmable gate array (FPGA), an image signal processor (ISP), and/or a communication processor, and may have a plurality of cores.

According to an embodiment, the electronic device 200 may include a battery (not shown). The battery may be electrically connected to the components of the electronic device 200. The battery may supply power to the components of the electronic device 200. For example, the battery may supply the power to the fingerprint sensor of the electronic device 200.

According to an embodiment, the electronic device 200 may include the circuit board (e.g., a printed circuit board (PCB), a printed board assembly (PBA), a flexible PCB (FPCB), or a rigid-flexible PCB (RFPCB)) for accommodating components to drive the electronic device 200. For example, the circuit board (not shown) may include at least one integrated circuit chip. At least one of the processor 240, the memory 250, a power management module (e.g., the power management module 188 of FIG. 1), or a communication module (e.g., the communication module 190 of FIG. 1) may be provided in the integrated circuit chip.

According to an embodiment, the circuit board (not shown) may be disposed inside a housing (e.g., the housing 210 of FIG. 2). For example, the circuit board may include a first circuit board and a second circuit board. According to an embodiment, the communication module may be mounted on the first circuit board, and the processor 240 may be mounted on the second circuit board. According to an embodiment, the circuit board may be electrically connected to the battery through a power transmission structure. According to an embodiment, the circuit board may be an interposer board.

According to an embodiment, the electronic device 200 may include the communication module (e.g., the communication module 190 of FIG. 1). The electronic device 200 may communicate with the external device 20 using the communication module. For example, the electronic device 200 may transmit or receive the user fingerprint information and/or information related to the fingerprint information to or from the external device 20 (e.g., the external electronic device 102, 104 of FIG. 1) using the communication module. For example, the electronic device 200 may transmit the obtained user fingerprint information (e.g., the second fingerprint information) to the external device 20, or receive user fingerprint information (e.g., the first fingerprint information) from the external device 20. However, it is not limited thereto.

According to an embodiment, the external device 20 may include at least one of, for example, a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MPEG audio layer 3 (MP3) player, a mobile medical device, a camera, or a wearable device. According to various embodiments, the external device 20 may include at least one of an accessory type (e.g., a watch, a ring, a bracelet, an anklet, a necklace, glasses, contact lenses, or a head-mounted device (HMD)), a fabric or clothing-integrated type (e.g., an electronic garment), a body-attached type (e.g., a skin pad or a tattoo), or a bio-implantable type (e.g., an implantable circuit).

In an embodiment, the external device 20 may be a home appliance. The home appliance may include, for example, at least one of a television, a digital video disk (DVD) player, an audio, a refrigerator, an air conditioner, a vacuum cleaner, an oven, a microwave oven, a washing machine, an air purifier, a set-top box, a home automation control panel, a security control panel, a television (TV) box, a game console, an electronic dictionary, an electronic key, a camcorder, or an electronic picture frame.

In an embodiment, the external device 20 may include at least one of various medical devices (e.g., various portable medical measuring devices (a blood glucose meter, a heart rate monitor, a blood pressure monitor, or a body temperature monitor), magnetic resonance angiography (MRA), magnetic resonance imaging (MRI), computer tomography (CT), a camera, or an ultrasound device), a navigation device, a global navigation satellite system (GNSS), an event data recorder (EDR), a flight data recorder (FDR), an automobile infotainment device, electronic equipment for ships (e.g., a navigation device for a ship or a gyrocompass), avionics, a security device, a head unit for vehicles, an industrial or household robot, an automatic teller’s machine (ATM) of an financial institution, a point of sales (POS) of a store, or an internet of things device (e.g., a light bulb, various sensors, an electric or gas meter, a sprinkler device, a fire alarm, a thermostat, a streetlight, a toaster, an exercise machine, a hot water tank, a heater, or a boiler).

According to an embodiment, the external device 20 may include at least one of a part of furniture or a building/structure, an electronic board, an electronic signature receiving device, a projector, or various measuring devices (e.g., a water, electricity, gas, or radio wave measuring device). In an embodiment, the external device 20 may be a combination of one or more of the various devices described above. The external device 20 according to an embodiment may be a flexible electronic device. In addition, the electronic device and the external device 20 according to the embodiment of this document are not limited to the devices mentioned above, and may include a new electronic device according to technological advancement.

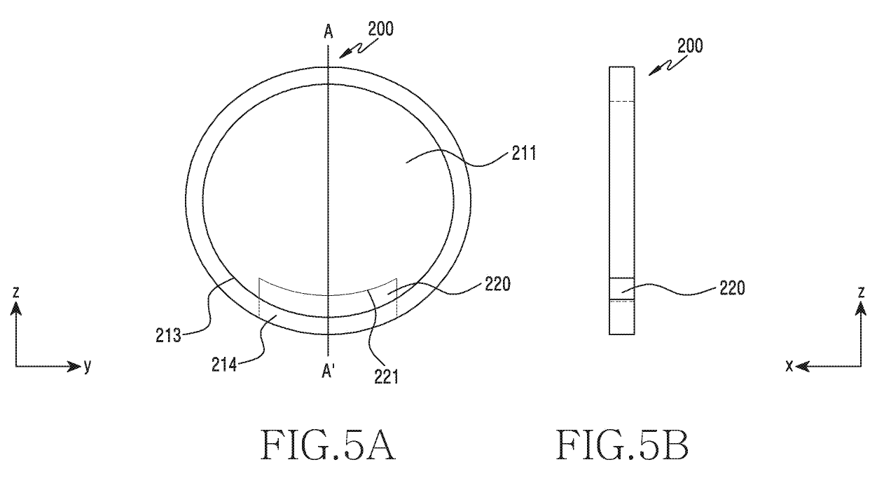

FIGS. 5A and 5B is a cross-sectional view of a wearable device (hereafter, referred to as an electronic device 200) according to an embodiment of the disclosure.

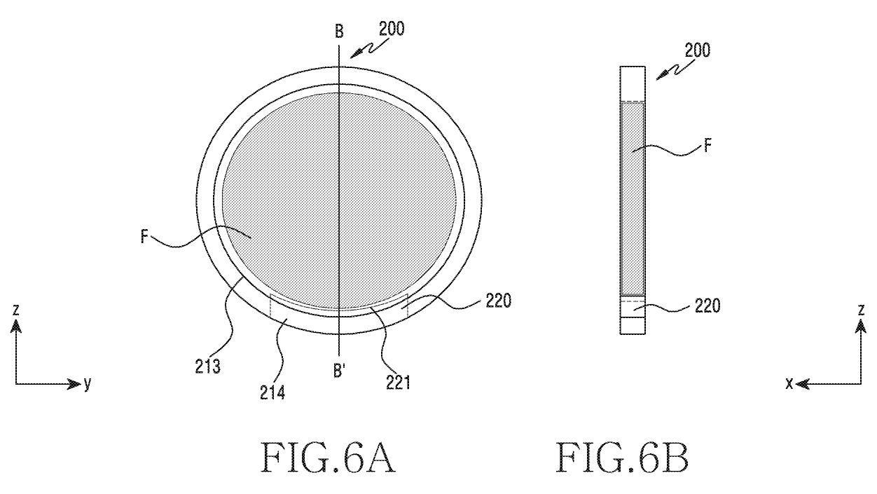

FIGS. 6A and 6B are cross-sectional views of a wearable device worn by a user according to an embodiment of the disclosure.

The electronic device 200 of FIGS. 5A, 5B, 6A and 6B may be referred to by the electronic device 101 of FIG. 1, the electronic device 200 of FIG. 2, the electronic device 200 of FIG. 3, and/or the electronic device 200 of FIG. 4. The same terms and/or the same reference numerals are used for components identical or substantially identical to those described above.

FIG. 5A may be the cross-sectional view of the electronic device 200 viewed from a direction (e.g., the x direction) in which at least one hole 211 is opened. FIG. 5B may be the cross-sectional view of the electronic device 200 taken along a line A-A’ of FIG. 5A.

Referring to FIG. 5A, the electronic device 200 according to an embodiment may include the button 220. According to an embodiment, the button 220 may be disposed on a portion facing the fingerprint region of the user’s finger. For example, the button 220 may be disposed on an inner surface forming the at least one hole 211 of the electronic device 200.

According to an embodiment, the button 220 may include a first surface 221 facing the fingerprint region of the user’s finger. According to an embodiment, the first surface 221 may include a shape allowing the button 220 to closely contact the fingerprint region of the user’s finger, with the user’s finger inserted into the electronic device 200. For example, the first surface 221 may include a shape corresponding to the fingerprint region of the user’s finger, with the user’s finger inserted into the electronic device 200. In one example, the first surface 221 may include a curved surface. For example, the first surface 221 may correspond to the shape of the inner surface 213 of the button 220. For example, a bending degree (or a warping degree) of the first surface 221 may be substantially the same as the bending degree (or the warping degree) of the inner surface 213. However, it is not limited thereto.

According to an embodiment, the button 220 may include a fingerprint sensor at a portion facing the fingerprint region of the user’s finger. For example, the button 220 may be disposed in a portion adjacent to the first surface 221. For example, the button 220 may be disposed on the first surface 221.

According to an embodiment, FIGS. 5A and 5B may be the diagram illustrating the state of the button 220 in a first state. According to an embodiment, the button 220 may be disposed in a recess 214 of the electronic device 200. For example, referring to FIGS. 5A and 5B, in case that the state of the button 220 is the first state, at least a portion of the button 220 may be accommodated inside the recess 214, and the remaining part of the button 220 may be visible from the outside of the electronic device 200. For example, the remaining part of the button 220 may protrude in a direction toward the at least one hole 211 based on the inner surface 213.

According to an embodiment, the first state of the button 220 may include a state of the button 220 in which the user is not wearing the electronic device 200. For example, the first state may include a state in which the button 220 is not pressed by the user’s finger, for example, in the -z direction, or the button 220 is not clicked. For example, the first state may include a state in which at least a portion of the user’s finger does not contact the button 220.

Referring to FIG. 6A, the cross-sectional view of the electronic device 200 worn by the user, viewed from a direction in which the at least one hole 211 is opened (e.g., the x direction). FIG. 6B may be the cross-sectional view of the electronic device 200 worn by the user, taken along the line A-A’ of FIG. 6A.

According to an embodiment, FIGS. 6A and 6B may be the diagram illustrating the state of the button 220 in a second state. Referring to FIGS. 5A and 5B, in case that the state of the button 220 is the second state, at least a portion of the button 220 may be accommodated in the recess 214, and the remaining part of the button 220 may be visible from the outside of the electronic device 200. For example, the remaining part of the button 220 may protrude in a direction toward the at least one hole 211 based on the inner surface 213. In the second state, the button 220 may be accommodated more inside the recess 214 than in the first state. In the first state, the button 220 may be more exposed to the outside of the electronic device 200 than in the second state. For example, in the first state, the button 220 may protrude further in a direction (e.g., the z direction) toward the at least one hole 211 based on the inner surface 213, than in the second state.

According to an embodiment, the second state of the button 220 may include a state of the button 220 in which the user wears the electronic device 200. For example, the second state may include a state in which the button 220 is pressed by the user’s finger F, for example, in the -z direction, or the button 220 is clicked. For example, the second state may include a state in which at least a portion of the user’s finger F contacts the button 220. According to an embodiment, in the second state, the first surface 221 of the button 220 may face the fingerprint region (e.g., the first portion S1 of FIG. 3) of the user’s finger F.

According to an embodiment, the button 220 may be changed by the user from the first state to the second state, or from the second state to the first state. For example, the button 220 may be guided (e.g., moved, slid) along the recess 214 by the user. For example, at least a portion of the button 220 may be inserted into the recess 214 by the user, or may protrude out of the recess 214. For example, the button 220 may be guided by a user’s input to the button 220 (e.g., a user’s input of pressing the button 220 or clicking the button) or by the user’s finger F removing from the button 220. For example, the button 220 may be guided in the z direction or the -z direction. According to an embodiment, the fingerprint sensor may be guided together with the button 220.

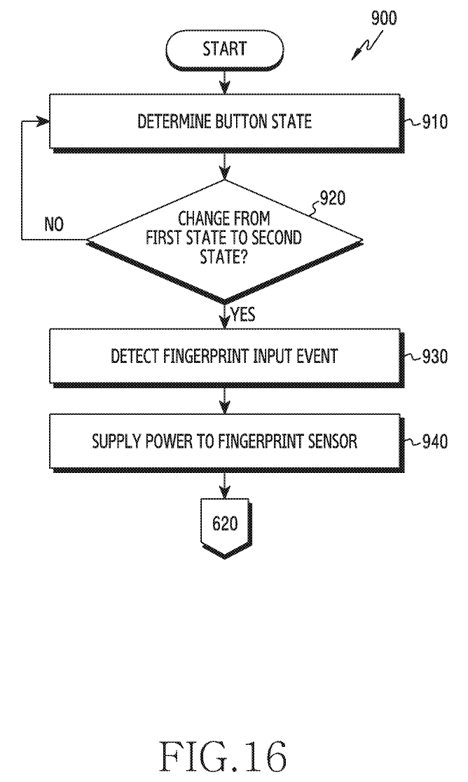

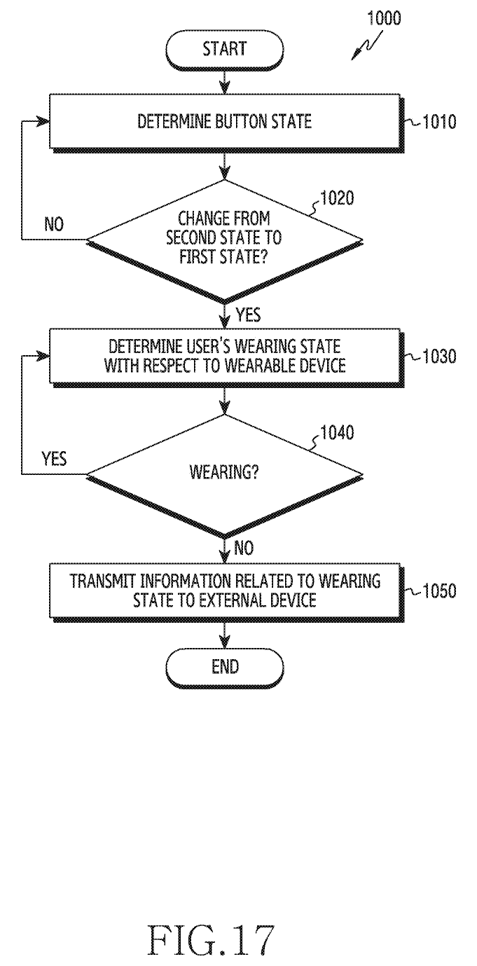

Operations related to the first state and/or the second state of the button 220 according to an embodiment shall be elucidated in FIGS. 16 and 17.

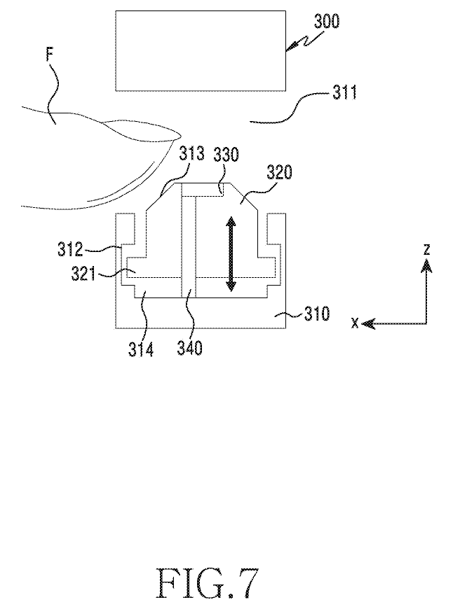

FIG. 7 is a cross-sectional view illustrating a wearable device 300 (hereafter, referred to as an electronic device 300) including a button 320 according to an embodiment of the disclosure.

Referring to FIG. 7, the electronic device 300 of FIG. 7 may be referred to by the electronic device 101 of FIG. 1, the electronic device 200 of FIG. 2, the electronic device 200 of FIG. 3, the electronic device 200 of FIG. 4, the electronic device 200 of FIGS. 5A and 5B and/or the electronic device 200 of FIGS. 6A and 6B. The same terms are used for components identical or substantially identical to those described above, and redundant descriptions thereof shall be omitted.

FIG. 7 illustrates that the user’s finger F is inserted into a hole 311 of the electronic device 300. According to an embodiment, the user’s finger may be inserted into the hole 311 of the electronic device 300 in a first direction (e.g., the -x direction). However, it is not limited thereto. For example, the user’s finger may also be inserted into the hole 311 in a second direction (e.g., the x direction) which is opposite to the first direction.

According to embodiment, at least a portion of the button 320 may be disposed inside the housing 310. For example, at least a portion of the button 320 may be disposed inside a recess 314 of the housing 310. In one example, the button 320 may be disposed to be spaced apart from the recess 314 by a specific distance. The button 320 may move inside the recess 314 while being spaced apart from the recess 314. For example, the button 320 may move in the z direction or the -z direction while being spaced apart from the recess 314.

According to an embodiment, the button 320 may include at least one protrusion 321. The at least one protrusion 321 may protrude to face in a direction (e.g., the x direction or the -x direction) substantially perpendicular to the direction (e.g., the z direction or the -z direction) in which the button 320 is guided.

According to embodiment, the housing 310 (or, the recess 314) may include at least one receiving portion 312 for receiving the at least one protrusion 321. In one example, the at least one receiving portion 312 may include a groove or a recess. However, it is not limited thereto.

According to an embodiment, the at least one protrusion 321 may be guided within the at least one receiving portion 312. For example, the at least one protrusion 321 may move or slide in a direction (e.g., the z direction or the −z direction) in which the button 320 is guided along the inside of the at least one receiving portion 312.

According to an embodiment, the at least one protrusion 321 and the at least one receiving portion 312 may limit a movement range of the button 320. For example, the button 320 may move within the recess 314 as much as the at least one protrusion 321 moves within the at least one receiving portion 312.

FIG. 7 illustrates that the button 320 includes the at least one protrusion 321, and the housing 310 (or, the recess 314) includes the at least one receiving portion 312, but it is not limited thereto. For example, the housing 310 (or, the recess 314) may include at least one protrusion which protrudes in a direction (e.g., the x direction or the -x direction) substantially perpendicular to the direction (e.g., the z direction or the -z direction) in which the button 320 is guided, and the button 320 may include at least one receiving portion which receives the at least one protrusion.

According to an embodiment, the button 320 may include a fingerprint sensor 330, and a connector 340 connected to the fingerprint sensor 330. The connector 340 may electrically interconnect the fingerprint sensor 330 and a circuit board (e.g., the circuit board of FIG. 4). In one example, the connector 340 may include an FPCB or a cable. However, it is not limited thereto.

According to an embodiment, the fingerprint sensor 330 may be disposed to face the user’s finger F. For example, the fingerprint sensor 330 may be disposed at one end of the button 320.

According to an embodiment, the button 320 may include at least one inclined surface 313 which forms an inclination angle with the direction in which the user’s finger F is inserted (e.g., the x direction or the -x direction). In one example, the at least one inclined surface 313 may form the inclination angle with a surface on which the fingerprint sensor 330 is disposed. However, it is not limited thereto. For example, the fingerprint sensor 330 may be further disposed on the at least one inclined surface 313. Since the button 320 includes the at least one inclined surface 313, inserting the user’s finger F into the hole 311 and pressing (or clicking) the button 320 with the user’s finger F may be improved.

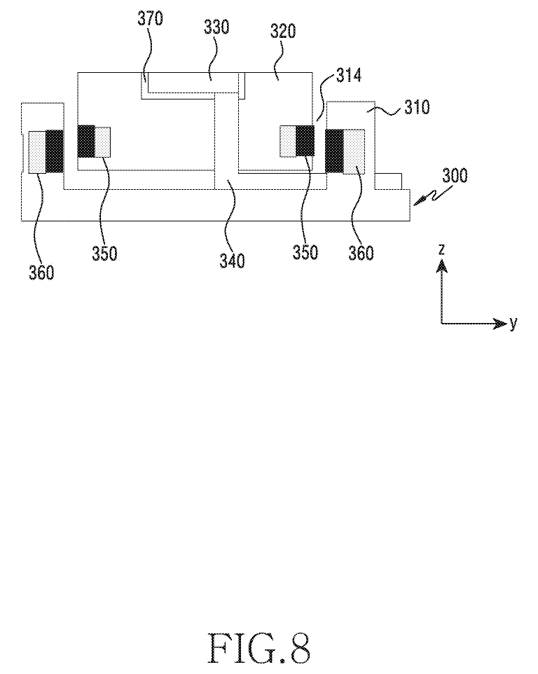

FIG. 8 is a cross-sectional view illustrating a wearable device 300 (hereafter, referred to as an electronic device 300) including a magnet according to an embodiment of the disclosure.

The electronic device of FIG. 8 may be referred to by the electronic device 101 of FIG. 1, the electronic device 200 of FIG. 2, the electronic device 200 of FIG. 3, the electronic device 200 of FIG. 4, the electronic device 200 of FIGS. 5A and 5B, the electronic device 200 of FIGS. 6A and 6B, and/or the electronic device 300 of FIG. 7. The same terms and/or the same reference numerals are used for components identical or substantially identical to those described above, and redundant descriptions thereof shall be omitted.

Referring to FIG. 8, the electronic device 300 according to an embodiment may include at least one magnet. For example, the electronic device 300 may include at least one first magnet 350 disposed on the button 320, and at least one second magnet 360 disposed on the housing 310 (or, the recess 314).

FIG. 8 illustrates that the button 320 includes one first magnet 350 on each of one side surface and the other side surface, but the number and the positions of the first magnet 350 are not limited thereto. For example, the button 320 may include a plurality of first magnets disposed along the direction (e.g., the z direction or the -z direction) in which the button 320 is guided, and/or a plurality of first magnets disposed along the direction (e.g., the x direction or the -x direction of FIG. 7) in which the user’s finger is inserted.

According to an embodiment, the at least one second magnet 360 may correspond to the at least one first magnet 350 respectively. For example, at least a portion of the at least one first magnet 350 may face at least a portion of the at least one second magnet 360. For example, the number of the at least one first magnet 350 may be equal to the number of the at least one second magnet 360. However, it is not limited thereto.

According to an embodiment, a repulsive force may be applied between the at least one first magnet 350 and the at least one second magnet 360. For example, the at least one first magnet 350 and the at least one second magnet 360 may be disposed to face each other with the same poles, in case that the button is in the second state. For example, the at least one first magnet 350 may include an S pole and an N pole in a direction substantially perpendicular to the direction in which the button 320 is guided (e.g., in the -y direction), and the at least one second magnet 360 corresponding to the at least one first magnet 350 may be disposed to include its N pole and S pole in the direction (e.g., the -y direction). However, it is not limited thereto. For example, the at least one first magnet 350 and the at least one second magnet 360 may be disposed to face each other with the same poles, in case that the button is in the first state.

According to an embodiment, due to the repulsive force between the at least one first magnet 350 and the at least one second magnet 360, the at least one second magnet 360 may repel the at least one first magnet 350. By the force of the at least one second magnet 360 repelling the at least one first magnet 350, the button 320 may be moved in a direction (e.g., the z direction) toward the hole (e.g., the hole 311 of FIG. 7) of the electronic device 300. For example, in case that the button 320 is in the second state (e.g., the second state of FIGS. 6A and 6B) (e.g., in case that the user presses the button 320), the button 320 may be moved toward the hole 311 of the electronic device 300 by the force of the at least one second magnet 360 repelling the at least one first magnet 350, and thus the button 320 may more closely contact the user’s finger. Hence, the fingerprint recognition function of the electronic device 300 may be improved. For example, a quality of the fingerprint information obtained by the electronic device 300 (e.g., the quality of the fingerprint image) may be improved.

According to an embodiment, the at least one first magnet 350 may be disposed inside the button 320. For example, the at least one first magnet 350 may be disposed inside a side surface (e.g., a side facing in the y direction or the -y direction) of the button 320. According to an embodiment, the at least one second magnet 360 may be disposed inside the housing 310 (or, the recess 314). For example, the at least one second magnet 360 may be disposed inside an inner surface (e.g., an inner surface facing in the y direction or the -y direction) facing the side surface of the button 320.

According to an embodiment, since the at least one first magnet 350 is disposed on the side surface of the button 320 and the at least one second magnet 360 is disposed on the surface facing the side surface of the button 320, the space in which the button 320 is mounted in the direction of guiding the button (e.g., the z direction or the -z direction) may be reduced. Thus, the space for mounting other components may be secured within the housing 310.

According to an embodiment, the electronic device 300 may include at least one shielding member 370. The at least one shielding member 370 may be disposed to shield the fingerprint sensor 330 from a magnetic field generated from a magnet (e.g., the at least one first magnet 350 and the at least one second magnet 360). For example, the at least one shielding member 370 may be disposed to surround at least a portion of at least one of the fingerprint sensor 330, the at least one first magnet 350, or the at least one second magnet 360.

According to an embodiment, the at least one shielding member 370 may include a material for shielding the fingerprint sensor 330 from the magnetic field generated from at least one magnet. For example, the at least one shielding member 370 may include a metal material. However, it is not limited thereto. the electronic device 300, which includes the at least one shielding member 370, may prevent or reduce performance degradation of the fingerprint sensor 330 caused by the magnet.

According to an embodiment, the at least one magnet (e.g., the at least one first magnet 350 and/or the at least one second magnet 360) may include a magnet magnetized with two poles. However, it is not limited thereto. For example, the at least one magnet may include a monopolar magnet or a multipolar magnet. For example, the at least one magnet may include an array magnet. For example, the at least one magnet may include a Halbach magnet. However, it is not limited thereto.

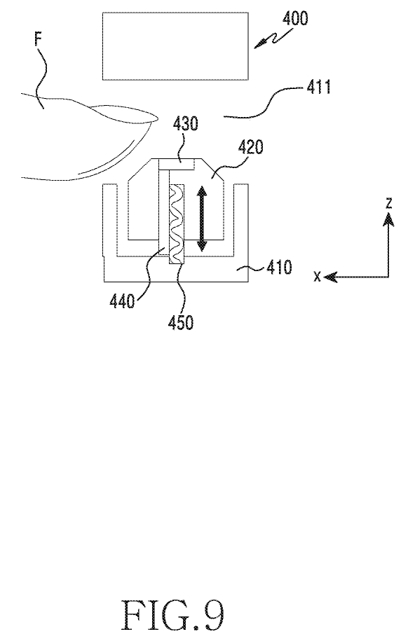

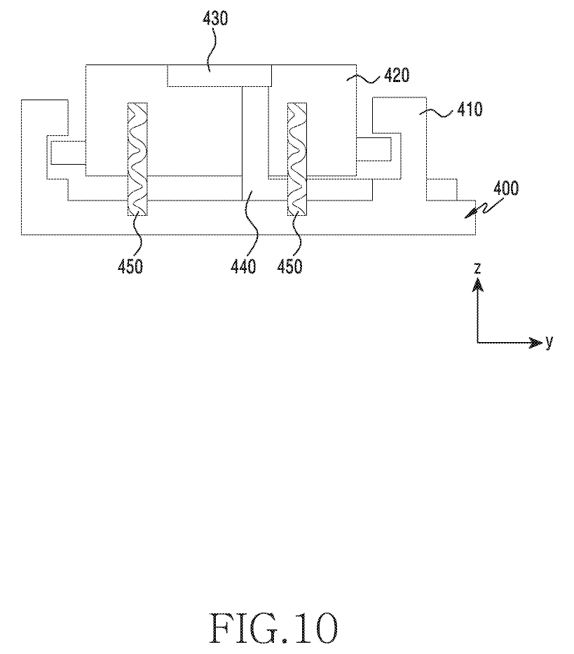

FIG. 9 is a cross-sectional view illustrating a wearable device 400 (hereafter, referred to as an electronic device 400) including a button 420 according to an embodiment of the disclosure. FIG. 10 is a cross-sectional view illustrating a wearable device 400 (hereafter, referred to as an electronic device 400) including an elastic member 450 according to an embodiment of the disclosure.

The electronic device 400 of FIGS. 9 and 10 may be referred to by the electronic device 101 of FIG. 1, the electronic device 200 of FIG. 2, the electronic device 200 of FIG. 3, the electronic device 200 of FIG. 4, the electronic device 200 of FIGS. 5A and 5B, the electronic device 200 of FIGS. 6A and 6B and/or the electronic device 300 of FIG. 7. The same terms and/or the same reference numerals are used for components identical or substantially identical to those described above, and redundant descriptions thereof shall be omitted.

Referring to FIGS. 9 and 10, the electronic device 400 according to an embodiment may include a housing 410 including at least one hole 411, a button 420 disposed on an inner surface (inside) of the housing 410, a fingerprint sensor 430 disposed on the button 420, and at least one elastic member 450 disposed between the housing 410 and the button 420. However, the components of the electronic device 400 are not limited to the components described above. For example, the electronic device 400 may omit at least one of the components mentioned above, or may further include at least one component. For example, the electronic device 400 may further include a connector 440 electrically connected to the fingerprint sensor 430.

According to an embodiment, the at least one elastic member 450 may be disposed to contract or relax in the direction (e.g., the z direction or the -z direction) of guiding the button 420. For example, the at least one elastic member 450 may be disposed between a rear surface (e.g., a surface facing in the -z direction) of the button 420 and a bottom surface (e.g., a surface facing in the z direction) of the recess.

According to an embodiment, the at least one elastic member 450 may include a member which contracts or relaxes. For example, the at least one elastic member 450 may include at least one of a coil or a spring.

According to an embodiment, by a restoring force of the at least one elastic member 450, the button 420 may be moved in a direction (e.g., the z direction) toward a hole (e.g., the hole 411 of FIG. 9) of the electronic device 400. For example, in case that the button 420 is in the second state (e.g., the second state of FIGS. 6A and 6B) (e.g., in case that the user presses the button 420), the restoring force of the at least one elastic member 450 may move the button 420 in the direction toward the hole 411 of the electronic device 400, and thus the button 420 may more closely contact the user’s finger. Hence, the fingerprint recognition function of the electronic device 400 may be improved. For example, the quality of fingerprint information obtained by the electronic device 400 (e.g., the quality of the fingerprint image) may be improved.

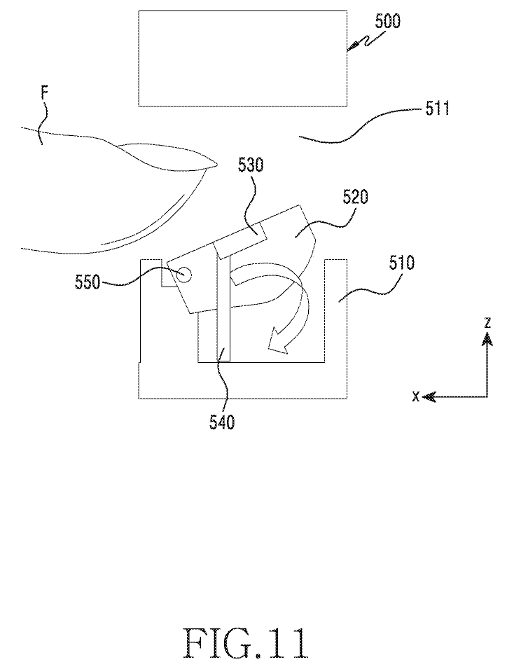

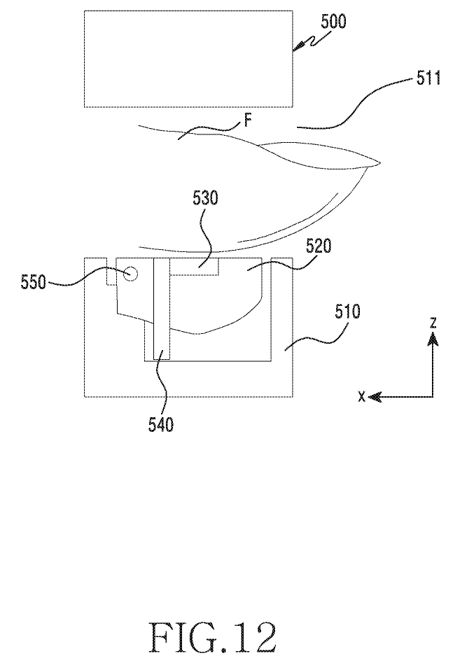

FIG. 11 is a cross-sectional view illustrating a wearable device 500 (hereafter, referred to as an electronic device 500) including a button 520 according to an embodiment of the disclosure. FIG. 12 is a diagram illustrating a wearable device 500 (hereafter, referred to as an electronic device 500) including a connecting member 550 according to an embodiment of the disclosure.

The electronic device 500 of FIGS. 11 and 12 may be referred to by the electronic device 101 of FIG. 1, the electronic device 200 of FIG. 2, the electronic device 200 of FIG. 3, the electronic device 200 of FIG. 4, the electronic device 200 of FIGS. 5A and 5B, the electronic device 200 of FIGS. 6A and 6B and/or the electronic device 300 of FIG. 7. The same terms and/or the same reference numerals are used for components identical or substantially identical to those described above, and redundant descriptions thereof shall be omitted.

Referring to FIGS. 11 and 12, the electronic device 500 according to an embodiment may include a housing 510 including at least one hole 511, the button 520 disposed inside (on an inner surface) of the housing 510, a fingerprint sensor 530 disposed on the button 520, and the at least one connecting member 550 for connecting the housing 510 and the button 520. However, the components of the electronic device 500 are not limited to the components described above. For example, the electronic device 500 may omit at least one of the components mentioned above, or may further include at least one component. For example, the electronic device 500 may further include a connector 540 electrically connected to the fingerprint sensor 530.

According to an embodiment, the at least one connecting member 550 may include a hinge structure. For example, the button 520 may be connected to the housing 510 through the hinge structure. The button 520 may move relative to the housing 510 based on the hinge structure. For example, the button 520 may tilt or roll about the hinge structure.

According to an embodiment, the at least one connecting member 550 may include an elastic member. For example, the at least one connecting member 550 may include a torsion spring. However, it is not limited thereto. For example, the at least one connecting member 550 may include at least one magnet.

According to an embodiment, the button 520 may be tilted or rolled toward the at least one hole 511 about the hinge structure by a restoring force of the at least one elastic member of the at least one connecting member 550. For example, one end of the button 520 may tilt or roll about the other end of the button 520 connected to the housing 510. For example, in case that the button 520 is in the first state (e.g., the state of the button 520 of FIG. 11), the one end of the button 520 may protrude toward the at least one hole 511. For example, in case that the button 520 is in the second state (e.g., the state of the button 520 of FIG. 12), at least a portion of the one end of the button 520 may be accommodated inside the housing 510.

According to an embodiment, by the restoring force of the at least one elastic member (e.g., a torsional spring) of the at least one connecting member 550, the one end of the button 520 may be moved in a direction (e.g., the z direction) toward the at least one hole 511 of the electronic device 500. For example, in case that the button 520 is in the second state (e.g., in case that the user presses the button 520), the one end of the button 520 may be moved by the restoring force of the at least one elastic member in the direction toward the hole 511 of the electronic device 500, and thus the button 520 may more closely contact the user’s finger. Accordingly, the fingerprint recognition function of the electronic device 500 may be improved. For example, fingerprint information quality obtained by the electronic device 500 (e.g., the quality of the fingerprint image) may be improved.

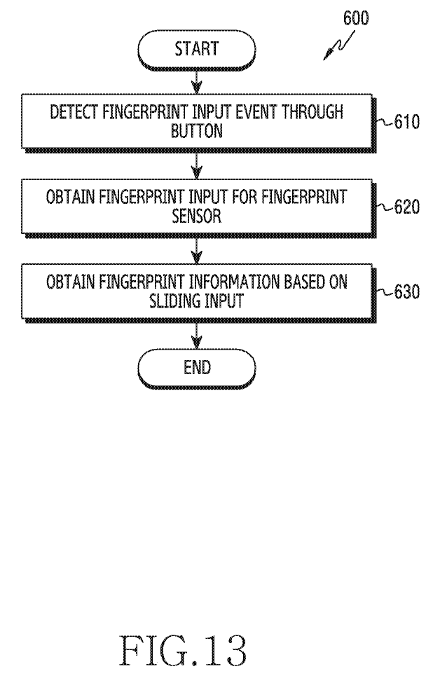

FIG. 13 is a flowchart illustrating an operation method 600 of a wearable device (e.g., the electronic device 200 of FIG. 2) according to an embodiment of the disclosure.

The wearable device (hereafter, referred to as the electronic device) and the operating method of FIG. 13 may be referred to by the electronic device 101 of FIG. 1, the electronic device 200 of FIG. 2, the electronic device 200 of FIG. 3, the electronic device 200 of FIG. 4, the electronic device 200 of FIGS. 5A and 5B, the electronic device 200 of FIGS. 6A and 6B, the electronic device 300 of FIG. 7, the electronic device 300 of FIG. 8, the electronic device 400 of FIG. 9, the electronic device 400 of FIG. 10, the electronic device 500 of FIG. 11 and/or the electronic device 500 of FIG. 12 described above. The same terms are used for components identical or substantially identical to those mentioned above, and redundant descriptions thereof shall be omitted.

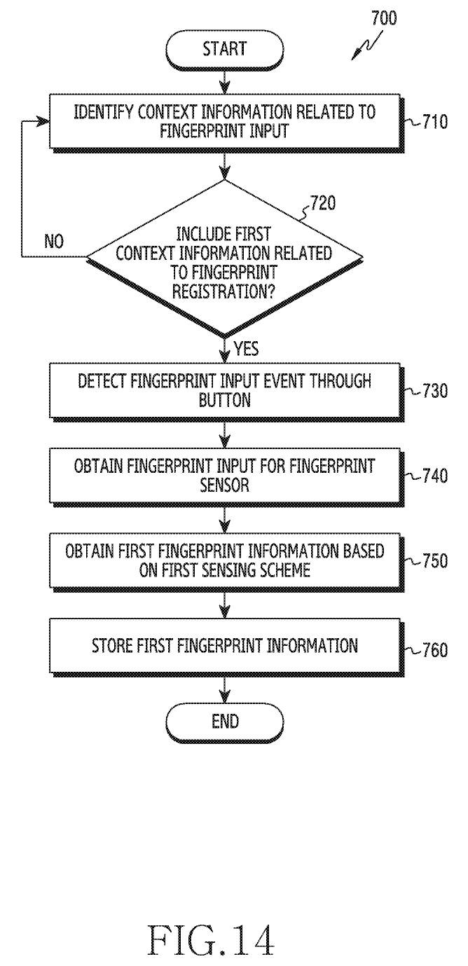

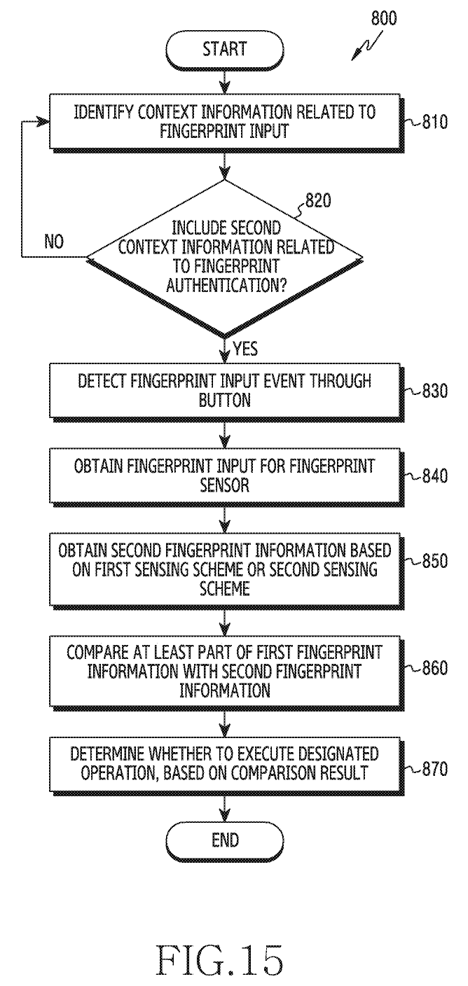

Referring to FIG. 13, the operating method 600 of the wearable device according to an embodiment may include an operation 610 of detecting a fingerprint input event through the button, an operation 620 of obtaining a fingerprint input for the fingerprint sensor, and an operation 630 of obtaining fingerprint information based on a sliding input. However, the operating method 600 of the wearable device is not limited to the operations described above. For example, the operating method 600 of the wearable device may omit at least one of the operations explained above, or may further include at least one operation. For example, the operating method 600 of the wearable device may further include at least one operation of a method 700 of FIG. 14, a method 800 of FIG. 15, a process 900 of FIG. 16, or a process 1000 of FIG. 17.

In the following embodiment, the operations may be performed sequentially, but are not necessarily performed sequentially. For example, the order of the operations may be changed, and at least two operations may be performed in parallel.

According to an embodiment, in operation 610, the electronic device (e.g., at least one processor) may detect a fingerprint input event through the button. For example, the electronic device may detect the fingerprint input event through a user’s input to the button. For example, the electronic device may detect a fingerprint input event through a user’s input of pressing the button or clicking the button.

According to an embodiment, the fingerprint input event may be defined variously. In one example, the fingerprint input event may be a start input of the fingerprint input obtained from the user. For example, selecting a button mapped to the fingerprint input may correspond to the fingerprint input event. In one example, the fingerprint input event may be an input for starting the fingerprint registration. For example, the fingerprint input event may include a start input of storing user fingerprint information in the electronic device (e.g., the wearable device 200 of FIG. 4) and/or an external device (e.g., the external device 20 of FIG. 4). In one example, the fingerprint input event may be an input of starting the fingerprint authentication. For example, the fingerprint authentication event may include a start input of comparing the user fingerprint information (e.g., fingerprint information obtained through the fingerprint registration operation) stored in the electronic device and/or the external device with the fingerprint information obtained from the user (e.g., fingerprint information obtained through the fingerprint authentication operation), and determining whether to execute a designated operation (e.g., unlocking or logging in) based on the comparison result.

According to an embodiment, operation 610 may include determining the state of the button (e.g., operation 910 of FIG. 16), determining whether the state of the button is changed by the user from the first state to the second state (e.g., operation 920 of FIG. 16), and/or detecting the fingerprint input event based on the state of the button changed from the first state to the second state (e.g., operation 930 of FIG. 16). Specific details regarding the above-described operations shall be described with reference to FIG. 16.

According to an embodiment, in operation 620, the electronic device (e.g., at least one processor) may, in response to detecting the fingerprint input event, obtain the fingerprint input for the fingerprint sensor disposed on the button. For example, in response to detecting the fingerprint input event, the electronic device may determine whether the fingerprint sensor recognizes the user’s finger. For example, the electronic device may execute the FOD mode to determine whether the fingerprint sensor recognizes the user’s finger.

In one example, in response to detecting the fingerprint input event, the electronic device may determine a type of the user fingerprint input to the fingerprint sensor. For example, in response to detecting the fingerprint input event, the electronic device may determine whether the user fingerprint input to the fingerprint sensor is a sliding input.

According to an embodiment, in operation 630, the electronic device (e.g., at least one processor) may obtain fingerprint information of the user through the fingerprint sensor, based on the sliding input to the fingerprint sensor. For example, in case that the electronic device performs the fingerprint registration operation, the electronic device may obtain first fingerprint information of the user based on the first sensing scheme. For example, in case that the electronic device performs the fingerprint authentication operation, the electronic device may obtain second fingerprint information of the user based on the first sensing scheme or the second sensing scheme.

According to an embodiment, the electronic device (e.g., at least one processor) may perform various operations using the obtained fingerprint information. In one example, in case that the electronic device performs the fingerprint registration operation, the electronic device may store the obtained first fingerprint information in the memory. For example, the electronic device may use the first fingerprint information stored in the memory in case that performing the fingerprint authentication operation. In one example, in case that the electronic device performs the fingerprint authentication operation, the electronic device may compare the obtained second fingerprint information with at least a portion of the first fingerprint information. For example, the electronic device may determine whether the obtained second fingerprint information and at least a portion of the first fingerprint information substantially match.

The process of the fingerprint registration operations of the wearable device according to an embodiment shall be specifically described in FIG. 14, and the process of the fingerprint authentication operations shall be specifically described in FIG. 15.

FIG. 14 is a flowchart illustrating a method of fingerprint registration operations according to an embodiment of the disclosure.

The wearable device (hereafter, referred to as the electronic device) of FIG. 14 may be referred to by the electronic device 101 of FIG. 1, the electronic device 200 of FIG. 2, the electronic device 200 of FIG. 3, the electronic device 200 of FIG. 4, the electronic device 200 of FIGS. 5A and 5B, the electronic device 200 of FIGS. 6A and 6B, the electronic device 300 of FIG. 7, the electronic device 300 of FIG. 8, the electronic device 400 of FIG. 9, the electronic device 400 of FIG. 10, the electronic device 500 of FIG. 11, the electronic device 500 of FIG. 12 and/or the electronic device of FIG. 13. The process of FIG. 14 may be referred to by the process of FIG. 13 described above. The same terms are used for components identical or substantially identical to those described above, and redundant descriptions thereof shall be omitted.

Referring to FIG. 14, the fingerprint registration operation method 700 of the wearable device according to an embodiment may include an operation 710 of identifying context information related to the fingerprint input, an operation 720 of determining whether the context information includes first context information related to the fingerprint registration, an operation 730 of detecting a fingerprint input event through the button, in response to determining that the context information includes the first context information, an operation 740 of obtaining a fingerprint input for the fingerprint sensor, an operation 750 of obtaining first fingerprint information based on the first sensing scheme, and an operation 760 of storing the first fingerprint information. However, the fingerprint registration operation method 700 of the wearable device is not limited to the above-mentioned operations. For example, the fingerprint registration operation method of the wearable device may omit at least one of the above-described operations, or may further include at least one other operation. For example, the fingerprint registration operation method of the wearable device may further include at least one operation of the process 900 of FIG. 16 or the process 1000 of FIG. 17.

In the following embodiment, the operations may be performed sequentially, but are not necessarily performed sequentially. For example, the order of the operations may be changed, and at least two operations may be performed in parallel.

According to an embodiment, in operation 710, the electronic device (e.g., at least one processor) may identify context information related to the fingerprint input to the fingerprint sensor. For example, the electronic device may receive a signal corresponding to execution of an application related to the fingerprint input from the external device (e.g., the external device 20 of FIG. 4). For example, the electronic device may identify whether a fingerprint input window is executed on the external device. For example, the electronic device may receive a signal corresponding to the fingerprint input window execution on the external device.

According to an embodiment, in operation 720, the electronic device (e.g., at least one processor) may determine whether the context information related to the fingerprint input to the fingerprint sensor includes first context information related to the fingerprint registration. For example, the electronic device may identify whether the application related to the fingerprint registration is executed on the external device. For example, the electronic device may identify whether the fingerprint registration window is executed on the external device. However, it is not limited thereto. For example, in operation 720, the external device may determine whether the context information related to the fingerprint input for the fingerprint sensor includes the first context information related to the fingerprint registration. Based on the determination result, the external device may transmit to the electronic device (e.g., at least one processor) a signal corresponding to the context information related to the fingerprint input including the first context information related to the fingerprint registration. The electronic device may receive from the external device a first signal corresponding to the context information related to the fingerprint input including the first context information related to the fingerprint registration.

According to an embodiment, in case that the electronic device (e.g., at least one processor) determines in operation 720 that the context information related to the fingerprint input to the fingerprint sensor includes the first context information related to the fingerprint registration, the electronic device (e.g., at least one processor) may detect a fingerprint input event through the button in operation 730. For example, the electronic device may detect the fingerprint input event through the input of the button mapped to the fingerprint input. Operation 730 may be referred to by operation 610 of FIG. 13 described above. For example, the method 600 of FIG. 13 may be performed after operation 720 of FIG. 14.

According to an embodiment, in case that the electronic device (e.g., at least one processor) determines in operation 720 that the context information related to the fingerprint input to the fingerprint sensor does not include the first context information related to the fingerprint registration, the electronic device (e.g., at least one processor) may identify the context information related to the fingerprint input. For example, the electronic device may receive a signal corresponding to execution of an application related to the fingerprint input from the external device (e.g., the external device 20 of FIG. 4).

According to an embodiment, in operation 740, the electronic device (e.g., at least one processor) may obtain a fingerprint input to the fingerprint sensor in response to detecting the fingerprint input event through the button. Operation 740 may be referred to by operation 620 of FIG. 13 mentioned earlier.

According to an embodiment, in operation 750, the electronic device (e.g., at least one processor) may obtain first fingerprint information of the user through the fingerprint sensor based on the first sensing scheme. For example, the electronic device may obtain the first fingerprint information for the fingerprint registration based on the first sensing scheme. Obtaining the first fingerprint information based on the first sensing scheme may include scanning fingerprint images corresponding to the fingerprint input at once through the fingerprint sensor. For example, obtaining the first fingerprint information based on the first sensing scheme may include sequentially acquiring a plurality of fingerprint image frames, and obtaining the first fingerprint information based on the plurality of fingerprint image frames obtained. For example, obtaining the first fingerprint information based on the first sensing scheme may include stitching the obtained plurality of fingerprint image frames to obtain the first fingerprint information. For example, obtaining the first fingerprint information based on the first sensing scheme may include scanning fingerprint images corresponding to a sliding input at once through the fingerprint sensor. For example, referring to FIG. 3, the first sensing scheme may include a scheme of scanning the fingerprint image of the first portion S1 of the user’s finger F which is slid at one time in case that the user’s finger F slides on the fingerprint sensor in contact with the fingerprint sensor.

According to an embodiment, in operation 760, the electronic device (e.g., at least one processor) may store the obtained first fingerprint information. For example, the electronic device may store the obtained first fingerprint information in the memory (e.g., the memory 250 of FIG. 4). For example, the electronic device may store the user’s first fingerprint information obtained in the fingerprint registration operation as the user’s fingerprint information in the memory. For example, the electronic device may store the first fingerprint information in the memory as reference fingerprint information to be compared with the user’s second fingerprint information obtained in the fingerprint authentication operation.

FIG. 15 is a flowchart illustrating a process of fingerprint authentication operations according to an embodiment of the disclosure.

The wearable device (hereafter, referred to as the electronic device) of FIG. 15 may be referred to by the electronic device 101 of FIG. 1, the electronic device 200 of FIG. 2, the electronic device 200 of FIG. 3, the electronic device 200 of FIG. 4, the electronic device 200 of FIGS. 5A and 5B, the electronic device 200 of FIGS. 6A and 6B, the electronic device 300 of FIG. 7, the electronic device 300 of FIG. 8, the electronic device 400 of FIG. 9, the electronic device 400 of FIG. 10, the electronic device 500 of FIG. 11, the electronic device 500 of FIG. 12, the electronic device of FIG. 13, and/or the electronic device of FIG. 14. The process of FIG. 15 may be referred to by the process of FIGS. 13 and/or 14 described above. The same terms are used for components identical or substantially identical to those described above, and redundant descriptions thereof shall be omitted.

Referring to FIG. 15, the fingerprint authentication operation method 800 of the wearable device according to an embodiment may include an operation 810 of identifying context information related to a fingerprint input, an operation 820 of determining whether second context information related to the fingerprint authentication is included, an operation 830 of detecting a fingerprint input event through the button, an operation 840 of obtaining a fingerprint history related to the fingerprint sensor, an operation 850 of obtaining second fingerprint information based on the first sensing scheme or the second sensing scheme, an operation 860 of comparing at least a portion of the first fingerprint information with the second fingerprint information, and an operation 870 of determining whether to execute a designated operation based on the comparison result. However, the fingerprint authentication operation method 800 of the wearable device is not limited to the above-described operations. For example, the fingerprint authentication operation method of the wearable device may omit at least one of the above-mentioned operations, or may further include at least one other operation. For example, the fingerprint authentication operation method of the wearable device may further include at least one operation of the process 900 of FIG. 16 or the process 1000 of FIG. 17.

In the following embodiment, the operations may be performed sequentially, but are not necessarily performed sequentially. For example, the order of the operations may be changed, and at least two operations may be performed in parallel.

According to an embodiment, in operation 810, the electronic device (e.g., at least one processor) may identify the context information related to the fingerprint input. For example, the electronic device may receive a signal corresponding to execution of an application related to the fingerprint input from the external device (e.g., the external device 20 of FIG. 4). For example, the electronic device may identify whether a fingerprint input window is executed on the external device. For example, the electronic device may receive a signal corresponding to the execution of the fingerprint input window on the external device.

According to an embodiment, in operation 820, the electronic device (e.g., at least one processor) may determine whether the context information related to the fingerprint input to the fingerprint sensor includes second context information related to the fingerprint authentication. For example, the electronic device may identify whether an application related to the fingerprint authentication is executed on the external device. For example, the electronic device may identify whether a fingerprint authentication window is executed on the external device. However, it is not limited thereto. For example, in operation 820, the external device may determine whether the context information related to the fingerprint input to the fingerprint sensor includes the second context information related to the fingerprint authentication. Based on the determination result, the external device may transmit a signal corresponding to the context information related to the fingerprint input including the second context information related to the fingerprint authentication to the electronic device (e.g., at least one processor). The electronic device may receive from the external device a second signal corresponding to the context information related to the fingerprint input including the second context information related to the fingerprint authentication.

According to an embodiment, in case that the electronic device (e.g., at least one processor) determines in operation 820 that the context information related to the fingerprint input to the fingerprint sensor includes the second context information related to the fingerprint authentication, the electronic device (e.g., at least one processor) may detect a fingerprint input event through the button in operation 830. For example, the electronic device may detect the fingerprint input event through an input of the button mapped to the fingerprint input. Operation 830 may be referred to by operation 610 of FIG. 13 described above. For example, the method 600 of FIG. 13 may be performed after operation 820 of FIG. 15.

According to an embodiment, in case that the electronic device (e.g., at least one processor) determines in operation 820 that the context information related to the fingerprint input to the fingerprint sensor does not include the second context information related to the fingerprint authentication, the electronic device (e.g., at least one processor) may identify the context information related to the fingerprint input. For example, the electronic device may receive a signal corresponding to execution of an application related to the fingerprint input from the external device (e.g., the external device 20 of FIG. 4).

According to an embodiment, in operation 840, the electronic device (e.g., at least one processor) may obtain a fingerprint input to the fingerprint sensor in response to detecting the fingerprint input event through the button. Operation 840 may be referred to by operation 620 of FIG. 13 described above.

According to an embodiment, in operation 850, the electronic device (e.g., at least one processor) may obtain the second fingerprint information of the user through the fingerprint sensor based on the first sensing scheme or the second sensing scheme.

In one example, the electronic device (e.g., at least one processor) may obtain the second fingerprint information for the fingerprint authentication based on the first sensing scheme. Obtaining the second fingerprint information based on the first sensing scheme may be referred to by obtaining the first fingerprint information based on the first sensing scheme (e.g., operation 750 of FIG. 14). For example, obtaining the second fingerprint information based on the first sensing scheme may include scanning a fingerprint image corresponding to the fingerprint input through the fingerprint sensor at one time. For example, obtaining the second fingerprint information based on the first sensing scheme may include scanning a fingerprint image corresponding to a sliding input through the fingerprint sensor at one time. For example, referring to FIG. 3, the first sensing scheme may include a scheme of scanning the fingerprint image of the first portion S1 of the user’s finger F which slides at one time in case that the user’s finger F slides on the fingerprint sensor in contact with the fingerprint sensor.

In one example, the electronic device (e.g., at least one processor) may obtain the second fingerprint information for the fingerprint authentication based on the second sensing scheme. For example, obtaining the second fingerprint information based on the second sensing scheme may include scanning a fingerprint image at a specific time point corresponding to the fingerprint input through the fingerprint sensor. For example, obtaining the second fingerprint information based on the second sensing scheme may include scanning one fingerprint image at a specific time point among fingerprint images corresponding to the sliding input through the fingerprint sensor. For example, referring to FIG. 3, the second sensing scheme may include a scheme of scanning the fingerprint image at a specific time point among the fingerprint images of the first portion S1 of the user’s finger F which slides, in case that the user’s finger F slides on the fingerprint sensor in contact with the fingerprint sensor.

According to an embodiment, the electronic device may perform the fingerprint authentication operations using the first sensing scheme or the second sensing scheme, thus improving convenience of the user fingerprint authentication operations. For example, the electronic device may improve a fingerprint scanning speed and an image processing speed of the electronic device, by performing the fingerprint authentication operations using the second sensing scheme. Hence, the convenience of the user fingerprint authentication operations may be improved.

According to an embodiment, in operation 860, the electronic device (e.g., at least one processor) may compare at least a portion of the first fingerprint information with the second fingerprint information. For example, the electronic device may compare at least a portion of the first fingerprint information stored in the memory with the obtained second fingerprint information. In one example, the first fingerprint information may include the first fingerprint information obtained in operation 750 of FIG. 14. In one example, the first fingerprint information may include the first fingerprint information stored in the memory in operation 760 of FIG. 14. However, it is not limited thereto. For example, the electronic device may receive the first fingerprint information from the external device (e.g., the external device 20 of FIG. 4). For example, the electronic device may compare the first fingerprint information received from the external device with the second fingerprint information obtained at the electronic device.

According to an embodiment, in operation 860, the electronic device (e.g., at least one processor) may determine whether at least a portion of the first fingerprint information corresponds to the second fingerprint information. For example, the electronic device may determine whether at least a portion of the first fingerprint information and at least a portion of the second fingerprint information match. In one example, in response to determining that at least a portion of the first fingerprint information and at least a portion of the second fingerprint information do not match, the electronic device may provide the user with information related to operation 840. For example, in case that the comparison result does not satisfy a designated condition, the electronic device may display a guide user interface (UI) requesting the fingerprint input on some region of a touch screen of the electronic device or the external device. In one example, the electronic device may perform operation 870, in response to determining that at least a portion of the first fingerprint information and at least a portion of the second fingerprint information match. In one example, in response to determining that the comparison result satisfies the designated condition, the electronic device may provide the user with information related to fingerprint authentication completion. For example, the electronic device may display a UI related to the fingerprint authentication completion on some region of the touch screen of the electronic device or the external device.

According to an embodiment, in operation 860, the electronic device (e.g., at least one processor) may determine the quality of information included in the obtained second fingerprint information. For example, the electronic device may determine the quality of the fingerprint image included in the obtained second fingerprint information. For example, the electronic device may determine the quality of the fingerprint image scanned at one time based on the first sensing scheme. For example, the electronic device may determine the quality of the fingerprint image scanned at a specific time point based on the second sensing scheme. In one example, the electronic device may provide the user with information related to operation 840, in response to determining that the quality of the obtained second fingerprint information (e.g., the quality of the fingerprint image) does not satisfy the designated condition. For example, in case that the quality of the second fingerprint information does not satisfy the designated condition, the electronic device may display a guide UI requesting the fingerprint input on some region of the touch screen of the electronic device or the external device. In one example, the electronic device may perform operation 870, in response to determining that the quality of the obtained second fingerprint information (e.g., the quality of the fingerprint image) satisfies the designated condition.

According to an embodiment, in operation 870, the electronic device (e.g., at least one processor) may determine whether to execute a designated operation, based on the comparison result. For example, in case that the comparison result satisfies the designated condition, the electronic device may determine whether to execute the designated operation in operation 870. For example, in case that the comparison result satisfies the designated condition, the electronic device may determine whether to execute an unlocking operation of the electronic device and/or the external device. However, it is not limited thereto. For example, in case that the comparison result satisfies the designated condition, the electronic device may determine whether to execute various operations such as a login operation or a payment operation.

In one example, in case that the comparison result satisfies the designated condition, the electronic device may provide the user with information related to the electronic device (e.g., the wearable device) or transmit it to the external device. For example, the electronic device may provide or transmit information related to a wearing direction in which the user wears the electronic device to the user or the external device. However, it is not limited thereto.

FIG. 16 is a flowchart illustrating a process 900 for controlling power of a fingerprint sensor based on a button state according to an embodiment of the disclosure.

The wearable device (hereafter, referred to as the electronic device) of FIG. 16 may be referred to by the electronic device 101 of FIG. 1, the electronic device 200 of FIG. 2, the electronic device 200 of FIG. 3, the electronic device 200 of FIG. 4, the electronic device 200 of FIGS. 5A and 5B, the electronic device 200 of FIGS. 6A and 6B, the electronic device 300 of FIG. 7, the electronic device 300 of FIG. 8, the electronic device 400 of FIG. 9, the electronic device 400 of FIG. 10, the electronic device 500 of FIG. 11, the electronic device 500 of FIG. 12, the electronic device of FIG. 13, the electronic device of FIG. 14, and/or the electronic device of FIG. 15. The process of FIG. 16 may be referred to by the processes of FIGS. 13, 14, and /or 15 described above. The same terms are used for components identical or substantially identical to those described above, and redundant descriptions thereof shall be omitted.

Referring to FIG. 16, the process 900 for controlling the power of the fingerprint sensor based on the button state according to an embodiment may include an operation 910 of determining the button state, an operation 920 of determining whether the button state changes from the first state to the second state, an operation 930 of detecting a fingerprint input event, and an operation 940 of supplying the power to the fingerprint sensor. However, the operations of the process 900 for controlling the power of the fingerprint sensor are not limited thereto. For example, the process 900 for controlling the power of the fingerprint sensor may omit at least one of the operations mentioned above, or may further include at least one other operation.

In the following embodiment, the operations may be performed sequentially, but are not necessarily performed sequentially. For example, the order of the operations may be changed, and at least two operations may be performed in parallel.

According to an embodiment, in operation 910, the electronic device (e.g., at least one processor) may determine the state of the button. For example, the electronic device may determine whether the state of the button is the first state (see the first state of FIGS. 5A and 5B) or the second state (see the second state of FIGS. 6A and 6B). For example, the electronic device may determine whether the button is pressed by a user’s finger (or, whether the button is clicked). For example, in case that the button is not pressed by the user’s finger, the electronic device may determine the state of the button as the first state. For example, in case that the button is pressed by the user’s finger, the electronic device may determine the state of the button as the second state.

According to an embodiment, in operation 920, the electronic device (e.g., at least one processor) may determine whether the state of the button is changed from the first state to the second state by the user. For example, the electronic device may determine whether the button is changed from the unpressed state to the pressed state by the user’s finger.

According to an embodiment, in response to determining that the state of the button changes from the first state to the second state in operation 920, the electronic device (e.g., at least one processor) may perform detecting a fingerprint input event in operation 930. For example, the electronic device may detect the fingerprint input event through an input of the button mapped to the fingerprint input. Operation 920 through operation 930 may be referred to by operation 610 of FIG. 13 described above.

According to an embodiment, in response to determining that the state of the button does not change from the first state to the second state in operation 920, the electronic device (e.g., at least one processor) may perform determining the state of the button. For example, the electronic device may determine the button state as the first state, in response to determining that the state of the button does not change from the first state to the second state.

According to an embodiment, in operation 940, the electronic device (e.g., at least one processor) may supply the power to the fingerprint sensor, in response to detecting the fingerprint input event. For example, the electronic device may supply the power the fingerprint sensor, in response to the button being pressed or clicked by the user (e.g., a finger of the user). Since the electronic device supplies the power upon detecting the fingerprint input event, power consumption of the electronic device may be prevented or reduced.

According to an embodiment, the electronic device (e.g., at least one processor) may perform operation 620 of FIG. 13, in response to supplying the power to the fingerprint sensor. For example, the electronic device may obtain a fingerprint input for the fingerprint sensor, in response to supplying the power the fingerprint sensor. The electronic device may obtain fingerprint information of the user based on the sliding input, in response to obtaining the fingerprint input to the fingerprint sensor. Operation 620 and subsequent operations may be referred to by the foregoing.

FIG. 17 is a flowchart illustrating a process 1000 for determining a user’s wearing state based on a button state according to an embodiment of the disclosure.

The wearable device (hereafter, referred to as the electronic device) of FIG. 17 may be referred to by the electronic device 101 of FIG. 1, the electronic device 200 of FIG. 2, the electronic device 200 of FIG. 3, the electronic device 200 of FIG. 4, the electronic device 200 of FIGS. 5A and 5B, the electronic device 200 of FIGS. 6A and 6B, the electronic device 300 of FIG. 7, the electronic device 300 of FIG. 8, the electronic device 400 of FIG. 9, the electronic device 400 of FIG. 10, the electronic device 500 of FIG. 11, the electronic device 500 of FIG. 12, the electronic device of FIG. 13, the electronic device of FIG. 14, the electronic device of FIG. 15, and/or the electronic device of FIG. 16. The process of FIG. 17 may be referred to by the processes of FIGS. 13, 14, 15, and/or 16 explained above. The same terms are used for components which are identical or substantially identical to those described above, and redundant explanations thereof shall be omitted.

Referring to FIG. 17, the process 1000 for determining the user’s wearing state based on the button state according to an embodiment may include an operation 1010 of determining the button state, an operation 1020 of determining that the button state is changed from the second state to the first state, an operation 1030 of determining the user’s wearing state with respect to the wearable device (the electronic device), in response to the button state changed from the second state to the first state, an operation 1040 of determining whether the user is wearing the electronic device, and an operation 1050 of transmitting information related to the wearing state to the external device, in response to determining that the user is not wearing the electronic device. However, the operations of the process 1000 of FIG. 17 are not limited thereto. For example, the process 1000 of FIG. 17 may omit at least one of the operations mentioned above, or may further include at least one other operation.

In the following embodiment, the operations may be performed sequentially, but are not necessarily performed sequentially. For example, the order of the operations may be changed, and at least two operations may be performed in parallel.

According to an embodiment, in operation 1010, the electronic device (e.g., at least one processor) may determine the state of the button. For example, the electronic device may determine whether the state of the button is the first state (see the first state of FIGS. 5A and 5B) or the second state (see the second state of FIGS. 6A and 6B). For example, the electronic device may determine whether the button is pressed by the user’s finger (or, whether the button is clicked). For example, in case that the button is not pressed by the user’s finger, the electronic device may determine the button state as the first state. For example, in case that the button is pressed by the user’s finger, the electronic device may determine the button state as the second state.

According to an embodiment, in operation 1020, the electronic device (e.g., at least one processor) may determine whether the button state is changed from the second state to the first state by the user. For example, the electronic device may determine whether the button is changed from the pressed state to the unpressed state by the user’s finger.

According to an embodiment, in response to determining that the button state is changed from the second state to the first state in operation 1020, the electronic device (e.g., at least one processor) may determine the wearing state of the user with respect to the wearable device (the electronic device) in operation 1030. For example, the electronic device may determine whether the wearing state of the user is wearing the electronic device or not wearing the electronic device. For example, in case that the button is in the first state, the electronic device may determine the wearing state as the state in which the user removes the electronic device. For example, in case that the button is in the second state, the electronic device may determine the wearing state as the state in which the user is wearing the electronic device. For example, in case that the button is changed from the first state to the second state, the electronic device may determine the wearing state as the state in which the user wears the electronic device. For example, in case that the button is changed from the second state to the first state, the electronic device may determine the wearing state as the state in which the user removes the electronic device.

According to an embodiment, in response to determining that the button state does not change from the second state to the first state in operation 1020, the electronic device (e.g., at least one processor) may perform determining the button state. For example, in response to determining that the button state does not change from the second state to the first state, the electronic device may determine the button state as the second state.

According to an embodiment, in response to determining that the user removes the electronic device in operation 1040, the electronic device (e.g., at least one processor) may transmit information related to the wearing state to the external device (e.g., the external device 20 of FIG. 4) in operation 1050. For example, the electronic device may transmit the information related to the user removing the electronic device to the external device.

According to an embodiment, in response to determining that the user is wearing the electronic device in operation 1040, the electronic device (e.g., at least one processor) may determine the wearing state of the user with respect to the wearable device (electronic device). For example, the electronic device may determine the wearing state of the user with respect to the electronic device as the state in which the user is wearing the electronic device.

As explained above, a wearable device (e.g., the electronic device 200 of FIG. 2) according to an embodiment may include a housing (e.g., the housing 210 of FIG. 2) including at least one hole (e.g., the at least one hole 211 of FIG. 2) into which a finger (e.g., the finger F of FIG. 3) of a user is inserted, a button (e.g., the button 220 of FIG. 2) disposed on an inner surface (e.g., the inner surface 213 of FIG. 2) facing the at least one hole of the housing, a fingerprint sensor (e.g., the fingerprint sensor 330 of FIG. 7) disposed on the button, and a processor (e.g., the at least one processor 240 of FIG. 4) connected to the fingerprint sensor. The at least one processor may detect a fingerprint input event through the button, in response to detecting the fingerprint input event, obtain a fingerprint input for the fingerprint sensor, and obtain fingerprint information of the user through the fingerprint sensor based on a sliding input to the fingerprint sensor.

According to an embodiment, the wearable device may further include memory. The at least one processor may identify context information related to the fingerprint input for the fingerprint sensor, in case that the context information related to the fingerprint input contains first context information related to fingerprint registration, obtain first fingerprint information of the user through the fingerprint sensor based on a first sensing scheme, and store the obtained first fingerprint information in the memory.

According to an embodiment, the at least one processor may acquire the first fingerprint information by scanning a fingerprint image corresponding to the fingerprint input at one time through the fingerprint sensor, based on the first sensing scheme.

According to an embodiment, the wearable device may further include memory. The at least one processor may be configured to identify context information related to a fingerprint input for the fingerprint sensor, in case that the context information related to the fingerprint input contains second context information related to fingerprint authentication, acquire second fingerprint information of the user through the fingerprint sensor based on a first sensing scheme or a second sensing scheme, compare at least a portion of the first fingerprint information stored in the memory with the second fingerprint information, and determine whether to execute a designated operation, based on the comparison result.

According to an embodiment, the at least one processor may acquire the second fingerprint information by scanning a fingerprint image corresponding to the fingerprint input at one time through the fingerprint sensor, based on the first sensing scheme.

According to an embodiment, the at least one processor may acquire the second fingerprint information by scanning a fingerprint image at a specific time point corresponding to the fingerprint input through the fingerprint sensor, based on the second sensing scheme.

According to an embodiment, the at least one processor may determine a state of the button, detect the fingerprint input event, based on the state of the button changed by the user from a first state to a second state, and, in response to detecting the fingerprint input event, supply power to the fingerprint sensor.

According to an embodiment, the at least one processor may determine a state of the button, based on the state of the button changed by the user from a second state to a first state, determine a wearing state of the user with respect to the wearable device, and, in response to determining that the user is not wearing the wearable device, transmit information related to the user wearing state of the wearable device to an external device.

According to an embodiment, the housing may include a recess for accommodating at least a portion of the button. The button may be disposed to protrude at least in part in a direction toward the at least one hole based on the inner surface of the housing, while being accommodated in the recess.

According to an embodiment, the wearable device may include at least one first magnet disposed on the button, and at least one second magnet facing the at least one first magnet and disposed on the housing.

According to an embodiment, the wearable device may include at least one shielding member disposed to surround at least a portion of at least one of the fingerprint sensor or the at least one first magnet.

According to an embodiment, the wearable device may include at least one elastic member disposed between the button and the housing. The at least one elastic member may include at least one of a coil or a spring.

As explained above, an operating method of a wearable device according to an embodiment may include detecting a fingerprint input event through a button disposed on an inner surface facing at least one hole of a housing which includes the at least one hole into which a finger of a user is inserted, in response to detecting the fingerprint input event, obtaining a fingerprint input for a fingerprint sensor disposed on the button, and obtaining fingerprint information of the user through the fingerprint sensor based on a sliding input to the fingerprint sensor.

According to an embodiment, the operating method of a wearable device may further include identifying context information related to a fingerprint input to the fingerprint sensor, in case that the context information related to the fingerprint input contains first context information related to fingerprint registration, acquiring first fingerprint information of the user through the fingerprint sensor based on a first sensing scheme, and storing the acquired first fingerprint information in memory.

According to an embodiment, acquiring the first fingerprint information based on the first sensing scheme may include obtaining the first fingerprint information by scanning a fingerprint image corresponding to the fingerprint input at one time through the fingerprint sensor.

According to an embodiment, the operating method of a wearable device may further include identifying context information related to a fingerprint input for the fingerprint sensor, in case that the context information related to the fingerprint input contains second context information related to fingerprint authentication, acquiring second fingerprint information of the user through the fingerprint sensor based on a first sensing scheme or a second sensing scheme, comparing at least a portion of the first fingerprint information stored in the memory with the second fingerprint information, and determining whether to execute a designated operation, based on the comparison result.

According to an embodiment, acquiring the second fingerprint information based on the first sensing scheme may include acquiring the second fingerprint information by scanning a fingerprint image corresponding to the fingerprint input at one time through the fingerprint sensor.

According to an embodiment, acquiring the second fingerprint information based on the second sensing scheme may include acquiring the second fingerprint information by scanning a fingerprint image at a specific time point corresponding to the fingerprint input through the fingerprint sensor.

According to an embodiment, detecting the fingerprint input event through the button may further include determining a state of the button, detecting the fingerprint input event, based on the state of the button changed by the user from a first state to a second state, and supplying power to the fingerprint sensor, in response to detecting the fingerprint input event.

According to an embodiment, the operating method of a wearable device may further include determining a state of the button, based on the state of the button changed by the user from a second state to a first state, determining a wearing state of the user with respect to the wearable device, and, in response to determining that the user is not wearing the wearable device, transmitting information related to the user wearing state of the wearable device to an external device.

The electronic device according to various embodiments of the disclosure may be a device of various types. The electronic device may include, for example, a portable communication device (e.g., a smartphone), a computer device, a portable multimedia device, a portable medical device, a camera, a wearable device, or a home appliance. The electronic device according to an embodiment of the disclosure is not limited to the devices described above.

It should be appreciated that various embodiments of the disclosure and the terms used therein are not intended to limit technological features disclosed in this document to particular embodiments, and embrace various modifications, equivalents, or alternatives of a corresponding embodiment. As used herein, each of such phrases as “A or B”, “at least one of A and B”, “at least one of A or B”, “A, B, or C”, “at least one of A, B, and C”, and “at least one of A, B, or C”, may include one, or all possible combinations of the items enumerated together in a corresponding one of the phrases. Such terms as “1st” and “2nd”, or “first” and “second” may be used to simply distinguish a corresponding component from another, and do not limit the corresponding components in other aspect (e.g., importance or order). If an element (e.g., a first element) is referred to, with or without the term “operatively” or “communicatively”, as “coupled” or “connected” to another element (e.g., a second element), it means that the element may be coupled with the other element directly (e.g., wiredly), wirelessly, or via a third element.

The term “module” used in various embodiments of the disclosure may include a unit implemented in hardware, software or firmware, and may be interchangeably used with a term, for example, logic, a logic block, a part, or circuitry. The module may be a single integral component, or a minimum unit or part thereof, for performing one or more functions. For example, according to an embodiment, the module may be implemented in a form of the ASIC.

Various embodiments of the disclosure may be implemented as software (e.g., the program 140) including one or more instructions which are stored in a storage medium (e.g., the internal memory 136 or the external memory 138) readable by a machine (e.g., the electronic device 101). For example, a processor (e.g., the processor 120) of the machine (e.g., the electronic device 101) may invoke at least one of the one or more instructions stored in the storage medium, and execute it or them. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Herein, ‘non-transitory’ simply means that the storage medium is a tangible device, and does not include a signal (e.g., an electromagnetic wave), but this term does not differentiate between a case where data is semi-permanently stored in the storage medium and a case where the data is temporarily stored.

According to an embodiment, a method according to various embodiments of the disclosure may be included and provided in a computer program product. The computer program product may be traded as a product between a seller and a buyer. The computer program product may be distributed in the form of a machine-readable storage medium (e.g., a compact disc read only memory (CD-ROM)), or may be distributed (e.g., downloaded or uploaded) directly or online via an application store (e.g., Play Store^{TM}) or between two user devices (e.g., smart phones). In the online distribution, at least a portion of the computer program product may be temporarily stored in the machine-readable storage medium such as memory of a manufacturer’s server, an application store server, or a relay server, or may be temporarily generated.

According to various embodiments, each component (e.g., a module or a program) of the above-described components may include a single entity or multiple entities. According to various embodiments, one or more components or operations of the above-described components may be omitted, or one or more other components or operations may be added. Alternatively or additionally, a plurality of components (e.g., modules or programs) may be integrated as a single component. In this case, the integrated component may perform one or more functions of each component of the plurality of the components in the same or similar manner as they are performed by a corresponding component of the plurality of the components before the integration. According to various embodiments, operations performed by the module, the program or other component may be carried out sequentially, in parallel, repeatedly, or heuristically, one or more of the operations may be executed in a different order or omitted, or one or more other operations may be added.

In the disclosure, a function or an operation performed by the electronic device may be performed by one or more processors executing one or more instructions stored in memory. The function or the operation of the electronic device mentioned in the disclosure may be carried out by one processor executing one or more instructions, or by a combination of a plurality of processors executing one or more instructions. The processor mentioned in the disclosure may be understood as including circuitry for performing computation or controlling other component of the electronic device. For example, the one or more processors may include a central processing unit (CPU), a micro-processor unit (MPU), an application processor (AP), a communication processor (CP), a neural processing unit (NPU), a system on chip (SoC) or an integrated circuit (IC) configured to execute one or more instructions. The one or more processors may be configured to perform the operation of the electronic devices described above.

In the disclosure, a program (software module, software) may be stored to random access memory, non-volatile memory including flash memory, read only memory (ROM), electrically erasable programmable ROM (EEPROM), a magnetic disc storage device, a CD-ROM, digital versatile discs (DVDs) or other optical storage devices, and a magnetic cassette. Alternatively, it may be stored to memory combining part or all of those recording media. The memory may include one storage medium, or may include a combination of a plurality of storage media. The one or more instructions may be stored in a single storage medium, or may be distributed and stored in a plurality of storage media.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable device comprising:
a housing including at least one hole into which a finger of a user is inserted;
a button disposed on an inner surface facing the at least one hole of the housing;
a fingerprint sensor disposed on the button;
memory for storing at least one computer program including computer-executable instructions; and
at least one processor communicatively coupled to the button, the fingerprint sensor and the memory,
wherein the instructions, when executed by the at least one processor individually or collectively, cause the wearable device to:
detect a fingerprint input event through the button,
in response to detecting the fingerprint input event, obtain a fingerprint input for the fingerprint sensor, and
obtain fingerprint information of the user through the fingerprint sensor based on a sliding input to the fingerprint sensor.

2. The wearable device of claim 1, wherein the instructions, when executed by the at least one processor individually or collectively, further cause the wearable device to:
identify context information related to the fingerprint input for the fingerprint sensor,
in case that the context information related to the fingerprint input contains first context information related to fingerprint registration, obtain first fingerprint information of the user through the fingerprint sensor based on a first sensing scheme, and
store the obtained first fingerprint information in the memory.

3. The wearable device of claim 2, wherein the instructions, when executed by the at least one processor individually or collectively, further cause the wearable device to:
acquire the first fingerprint information by scanning a fingerprint image corresponding to the fingerprint input at one time through the fingerprint sensor, based on the first sensing scheme.

4. The wearable device of claim 3, wherein the instructions, when executed by the at least one processor individually or collectively, further cause the wearable device to:
identify context information related to a fingerprint input for the fingerprint sensor,
in case that the context information related to the fingerprint input contains second context information related to fingerprint authentication, acquire second fingerprint information of the user through the fingerprint sensor based on a first sensing scheme or a second sensing scheme,
compare at least a portion of the first fingerprint information stored in the memory with the second fingerprint information, and
determine whether to execute a designated operation, based on the comparison result.

5. The wearable device of claim 4, wherein the instructions, when executed by the at least one processor individually or collectively, further cause the wearable device to:
acquire the second fingerprint information by scanning a fingerprint image corresponding to the fingerprint input at one time through the fingerprint sensor, based on the first sensing scheme.

6. The wearable device of claim 4, wherein the instructions, when executed by the at least one processor individually or collectively, further cause the wearable device to:
acquire the second fingerprint information by scanning a fingerprint image at a specific time point corresponding to the fingerprint input through the fingerprint sensor, based on the second sensing scheme.

7. The wearable device of claim 1, wherein the instructions, when executed by the at least one processor individually or collectively, further cause the wearable device to:
determine a state of the button,
detect the fingerprint input event, based on the state of the button changed by the user from a first state to a second state, and
in response to detecting the fingerprint input event, supply power to the fingerprint sensor.

8. The wearable device of claim 1, wherein the instructions, when executed by the at least one processor individually or collectively, further cause the wearable device to:
determine a state of the button,
based on the state of the button changed by the user from a second state to a first state, determine a wearing state of the user with respect to the wearable device, and
in response to determining that the user is not wearing the wearable device, transmit information related to the user wearing state of the wearable device to an external device.

9. The wearable device of claim 1,
wherein the housing includes a recess for accommodating at least a portion of the button, and
wherein at least a portion of the button is disposed to protrude in a direction toward the at least one hole based on the inner surface of the housing, while being accommodated in the recess.

10. The wearable device of claim 1, further comprising:
at least one first magnet disposed on the button; and
at least one second magnet facing the at least one first magnet and disposed on the housing.

11. The wearable device of claim 10, further comprising:
at least one shielding member disposed to surround at least a portion of at least one of the fingerprint sensor or the at least one first magnet.

12. The wearable device of claim 1, further comprising:
at least one elastic member disposed between the button and the housing,
wherein the at least one elastic member includes at least one of a coil or a spring.

13. An operating method of a wearable device, comprising:
detecting, by the wearable device, a fingerprint input event through a button disposed on an inner surface facing at least one hole of a housing including the at least one hole into which a finger of a user is inserted;
in response to detecting the fingerprint input event, obtaining, by the wearable device, a fingerprint input for a fingerprint sensor disposed on the button; and
obtaining, by the wearable device, fingerprint information of the user through the fingerprint sensor based on a sliding input to the fingerprint sensor.

14. The operating method of claim 13, further comprising:
identifying context information related to a fingerprint input to the fingerprint sensor;
in case that the context information related to the fingerprint input contains first context information related to fingerprint registration, acquiring first fingerprint information of the user through the fingerprint sensor based on a first sensing scheme; and
storing the acquired first fingerprint information in memory.

15. The operating method of claim 14, wherein acquiring the first fingerprint information based on the first sensing scheme comprises obtaining the first fingerprint information by scanning a fingerprint image corresponding to the fingerprint input at one time through the fingerprint sensor.

16. The operating method of claim 15, further comprising:
identifying context information related to a fingerprint input for the fingerprint sensor;
in case that the context information related to the fingerprint input contains second context information related to fingerprint authentication, acquiring second fingerprint information of the user through the fingerprint sensor based on a first sensing scheme or a second sensing scheme;
comparing at least a portion of the first fingerprint information stored in memory with the second fingerprint information; and
determining whether to execute a designated operation, based on the comparison result.

17. The operating method of claim 16, wherein acquiring the second fingerprint information based on the first sensing scheme includes acquiring the second fingerprint information by scanning a fingerprint image corresponding to the fingerprint input at one time through the fingerprint sensor.

18. The operating method of claim 16, wherein acquiring the second fingerprint information based on the second sensing scheme includes acquiring the second fingerprint information by scanning a fingerprint image at a specific time point corresponding to the fingerprint input through the fingerprint sensor.

19. The operating method of claim 13,
wherein detecting the fingerprint input event through the button further includes:
determining a state of the button, and
detecting the fingerprint input event, based on the state of the button changed by the user from a first state to a second state, and
wherein the operating method further comprises supplying power to the fingerprint sensor, in response to detecting the fingerprint input event.

20. The operating method of claim 13, further comprising:
determining a state of the button, based on the state of the button changed by the user from a second state to a first state;
determining a wearing state of the user with respect to the wearable device; and
in response to determining that the user is not wearing the wearable device, transmitting information related to the user wearing state of the wearable device to an external device.
